(19) United States
(12) Patent Application Publication
(10) Pub. No.: US 2019/0391599 A1
(43) Pub. Date: Dec. 26, 2019

(54) AEROSTAT NETWORK

(71) Applicant: Mothership Aeronautics Limited, San Mateo, CA (US)

(72) Inventor: Jonathan Leopold Nutzati Fontaine, South San Francisco, CA (US)

(73) Assignee: Mothership Aeronautics Limited, San Mateo, CA (US)

(21) Appl. No.: 16/355,695

(22) Filed: Mar. 15, 2019

Related U.S. Application Data
(60) Provisional application No. 62/658,761, filed on Apr. 17, 2018.
(60) Provisional application No. 62/643,689, filed on Mar. 15, 2018.

(51) Int. Cl. G05D 1/12; H04W 4/42; B64D 5/00; B64C 39/02; B64D 47/00; B64C 1/22

(52) U.S. Cl. CPC G05D 1/12; H04W 4/42; B64D 5/00; H04W 84/005; B64D 47/00; B64C 1/22; B64C 39/024

(57) ABSTRACT

Disclosed is a network of aerostats. An aerostat network management system is in communication with intranodal management systems of respective aerostat network nodes. Aerostats keep an airborne platform in the air at each aerostat network node. Internodal conveyances carry cargo, passengers, or data from one aerostat network node to another. The internodal conveyances can include unmanned aircraft vehicles (UAVs).

### CROSS-REFERENCE TO RELATED APPLICATIONS

This application claims priority to U.S. Provisional Patent Application No. 62/643,689, filed Mar. 15, 2018, and U.S. Provisional Patent Application No. 62/658,761, filed Apr. 17, 2018, both of which are incorporated by reference herein.

### BRIEF DESCRIPTION OF THE DRAWINGS

FIG. 1 is a diagram of an example of an aerostat network comprising multiple aerostat network nodes with internodal conveyance.

FIG. 2A is a diagram of an example of an aerostat network topology with the aerostat nodes arranged in series.

FIG. 2B is a diagram of an example of an aerostat network topology with aerostat nodes arranged in a hub-and-spoke configuration.

FIG. 2C is a diagram of an example of an aerostat network topology with aerostat nodes arranged in a mesh configuration.

FIG. 3A is a top view diagram of an example of an airborne aircraft carrier suitable for use at an aerostat network node.

FIG. 3B is a top view diagram of an example of an airborne aircraft carrier suitable for use at an aerostat network node.

FIG. 3C is a side view diagram of an example of an airborne aircraft carrier suitable for use at an aerostat network node.

FIG. 4 is a diagram of an example of an aerostat network with carrier-capable aircraft that travel between aerostat nodes.

FIG. 5 is a flowchart of an example of a method for payload transportation using an aerostat network with carrier-capable aircraft that travel between aerostat nodes.

FIG. 6 is a diagram of an example of a mobile aerostat node with carrier-capable surveillance aircraft.

FIG. 7 is a flowchart of an example of a method for conducting surveillance of a target using a mobile aerostat node.

FIG. 8 is a diagram of an example of a mobile aerostat node with carrier-capable surveillance aircraft.

FIG. 9 is a flowchart of an example of a method for conducting surveillance of a target using an aerostat node.

FIG. 10 is a diagram 1000 of an example of an aerostat network system with carrier-capable aircraft that travel between aerostat nodes.

FIG. 11 is a flowchart of an example of a method for payload transportation using an aerostat network with carrier-capable aircraft that travel between aerostat nodes.

FIG. 12 is a diagram of an example of an aerostat network with intranodal conveyances.

FIG. 13 is a diagram of an example of a method for moving an internodal conveyance through an aerostat network.

FIG. 14 is a diagram of an example of an aerostat network management system.

### DETAILED DESCRIPTION

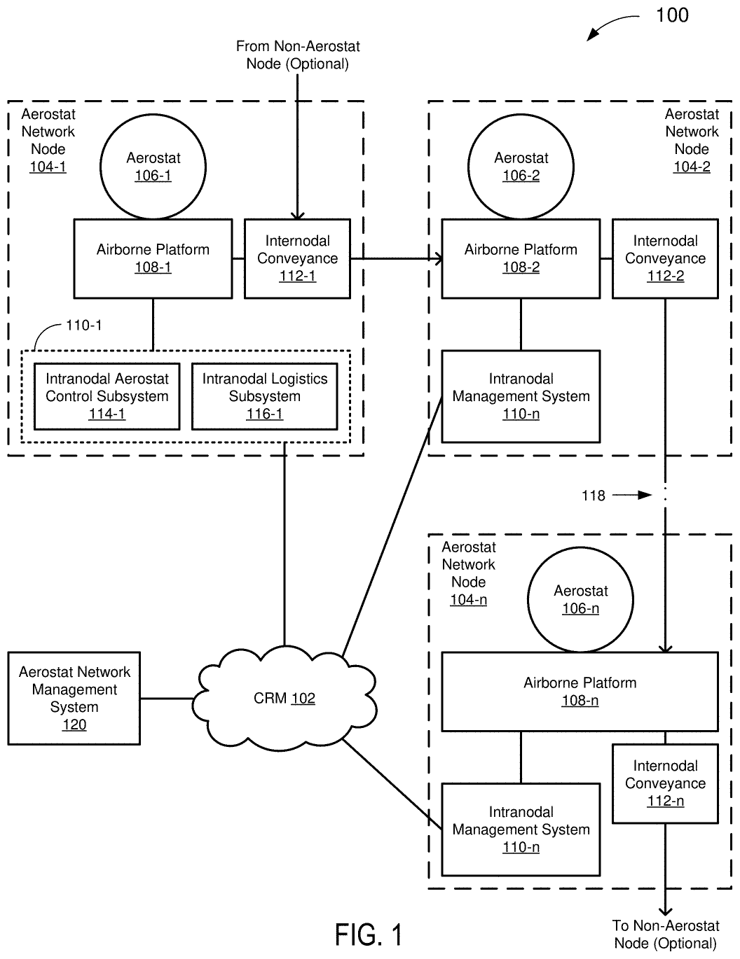

FIG. 1 is a diagram 100 of an example of an aerostat network comprising multiple aerostat network nodes with internodal conveyance. The diagram 100 includes a computer readable medium (CRM) 102, aerostat network nodes 104-1 to 104-n (collectively, the aerostat network nodes 104) coupled to the CRM 102, and an aerostat network management system 120 coupled to the CRM 102. An aerostat network can be characterized as a plurality of interconnected aerostat nodes, wherein each aerostat node includes at least one aerostat. Data, cargo, or passengers (“payload”) is conveyed along a path from an ordinally first aerostat node through zero or more intermediate nodes to an ordinally last aerostat node of the path. Payload may also be gathered in transit. For example, data gathered from inspecting a pipeline can be accumulated in transit between nodes. In a telecommunications context, payload is the “message” or “signal” part of a conveyance; in a commercial context, payload is the revenue-generating cargo or passengers; payload can be considered that portion of the aerostat network that is not part of infrastructure or transportation overhead.

The use of an aerostat enables permanent or semi-permanent airborne communications, freight, passenger, or aircraft docking nodes (e.g., terminals). In a specific implementation, an aerostat network can be characterized as having a “route structure.” Arrows between aerostat nodes in the example of FIG. 1 are intended to represent the route structure for the network. In an implementation that utilizes aircraft to convey payload, the arrow between aerostat nodes is intended to represent the path taken by the aircraft; the aircraft can use the aerostat nodes as docking stations to recharge, upload data, or download software updates, to name a few possibilities. In an implementation that utilizes electromagnetic transmissions to convey payload, the arrows between aerostat nodes is intended to represent the path taken by the signals, which may include intermittent use of non-aerostat node relays, such as satellites, cell towers, or the like. In these ways, the aerostat nodes are interconnected or “operationally connected” to one another.

The CRM 102 is intended to represent a variety of potentially applicable technologies. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. For example, the CRM 102 can be used to form a network or part of a network. Where two components are co-located on a device, the CRM 102 can include a bus or other data conduit or plane. Where a first component is co-located on one device and a second component is located on a different device, the CRM 102 can include a network.

In a specific implementation, the CRM 102 includes an infrastructure network, which can be coupled to or form a part of a larger network, such as the Internet. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet. The example of FIG. 1 is intended to illustrate a CRM 102 that may or may not include more than one private network.

A computer system, as used in this paper, can include or be implemented as a specifically-purposed computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific, configuration-specific, or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Referring once again to the example of FIG. 1, the aerostat network nodes 104 are intended to represent available nodes on a network path through which payload is conveyed. An aerostat network can be connected to non-aerostat nodes of a telecommunications, freight, or transit network. The edge of an aerostat network that is linked to a non-aerostat network node, such as an airport, seaport, inland shipping dock, rail terminal, truck terminal, and/or intermodal terminal can be referred to as a gateway aerostat node. By definition, a gateway aerostat node is not part of a non-aerostat network node (and is a part of an aerostat network), but it may be considered part of an aerostat subnetwork for which it acts as a gateway or may be considered not part of the aerostat subnetwork(s) for which it acts as a gateway. In an implementation in which payload is received from a non-aerostat node, the aerostat network node 104-1 can be considered a gateway aerostat node. In an implementation in which payload is sent to a non-aerostat node, the aerostat network node 104-n can be considered a gateway aerostat node. In most implementations, it is expected payload will enter an aerostat network at a first gateway aerostat node (from a pickup location or branch station) and exit the aerostat network at a second gateway aerostat node (to a final destination or branch station), with the potential for intervening gateway aerostat nodes and non-aerostat network nodes along the transportation path from the first gateway aerostat node to the second gateway aerostat node.

The aerostat network nodes 104 depicted in the example of FIG. 1 can represent all of the nodes of an aerostat network having an aerostat network topology with the aerostat nodes arranged in series; a subplurality of nodes of an aerostat network having an aerostat network topology with the aerostat nodes arranged in series, as hub-and-spokes, or as a mesh. The aerostat network nodes 104 can also represent a path through a number of subnetworks, including aerostat subnetworks and non-aerostat subnetworks. The dotted line identified with reference numeral 118 in the example of FIG. 1 is intended to demonstrate the number of aerostat nodes 104 can be from one to ‘n.’

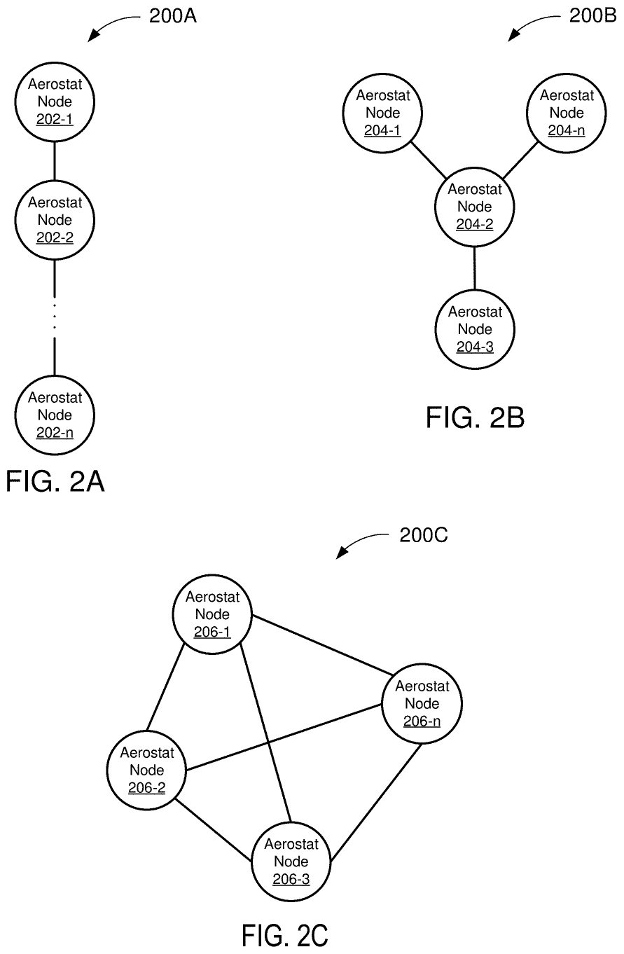

FIGS. 2A, 2B, and 2C are intended to illustrate aerostat network topologies. FIG. 2A is a diagram 200A of an example of an aerostat network topology with the aerostat nodes arranged in series. The diagram 200A includes aerostat nodes 202-1 to 202-n (collectively, the aerostat nodes 202). In an example of operation, when payload is conveyed from the aerostat node 202-1 to the aerostat node 202-n, payload is conveyed first from the aerostat node 202-1 to intervening nodes (including, e.g., the aerostat node 202-2), if any, and finally to the aerostat node 202-n. If the path is bi-directional, the payload can also be conveyed in the opposite direction, as well, from the aerostat node 202-n to the aerostat node 202-1. Also, payload need not be conveyed beyond an intended destination (e.g., payload could be conveyed from the aerostat node 202-1 to the aerostat node 202-2, its intended destination, and not continue on to the aerostat node 202-n, or from the aerostat node 202-n to the aerostat node 202-2 and not continue on to the aerostat node 202-1).

FIG. 2B is a diagram 200B of an example of an aerostat network topology with aerostat nodes arranged in a hub-and-spoke configuration. The hub-and-spoke topology is often referred to as a star network topology in the telecommunications and information technology sector. The diagram 200B includes aerostat nodes 204-1 to 204-n (collectively, the aerostat nodes 204). More particularly, the aerostat node 204-2 is located at a hub of the hub-and-spoke configuration and aerostat nodes 204-1 and 204-3 to 204-n are arranged at spoke ends of the hub. In an example of operation, when payload is conveyed from an aerostat at a spoke end (e.g., the aerostat node 204-1) to another aerostat at another spoke end (e.g., the aerostat node 204-3), the payload is conveyed from the aerostat node 204-1 to the aerostat node 204-2 at the hub, and then to the aerostat node 204-3. If the path is bi-directional, the payload can also be conveyed in the opposite direction, as well, from the aerostat node 204-3 through the aerostat node 204-2 at the hub, to the aerostat node 204-1.

FIG. 2C is a diagram 200C of an example of an aerostat network topology with aerostat nodes arranged in a mesh configuration. The mesh topology may also be referred to as a point-to-point topology. The diagram 200C includes aerostat nodes 206-1 to 206-n (collectively, the aerostat nodes 206). More particularly, the aerostat nodes are each directly (i.e., without any intervening nodes) coupled to one another. In an example of operation, payload can be conveyed from the aerostat node 206-1 to any of the aerostat nodes 206-2 to 206-n without passing through an intermediary aerostat node. If the path is bi-directional, the payload can also be conveyed in the opposite direction, as well, from one of the aerostat nodes 206-2 to 206-n to the aerostat node 206-1 without passing through an intermediate aerostat node.

In some aerostat network implementations, an arrangement of the aerostat nodes is combination of two or more of the topologies described above with reference to FIGS. 2A, 2B, and 2C. For example, an arrangement of aerostat nodes in an aerostat network may include two or more of an aerostat subnetwork with a serial topology, an aerostat subnetwork with a hub-and-spoke topology, and an aerostat subnetwork with a mesh topology. The aerostat node that connects two subnetworks may be referred to as a bridging aerostat node. A bridging aerostat node may be considered part of one, both, or neither of the aerostat subnetworks it bridges. A bridging node may have different internodal conveyances for the different subnetworks it bridges (e.g., use different frequencies or channels for transmissions or different mechanisms, such as zipline and aircraft or different aircraft, for passengers or cargo).

Referring once again to the example of FIG. 1, the aerostat network nodes 104 depicted in the diagram 100 include aerostats 106-1 to 106-n (collectively the aerostats 106), airborne platforms 108-1 to 108-n (collectively the airborne platforms 108) connected to, and capable of being carried by, the respective aerostats 106, intranodal management systems 110-1 to 110-n (collectively the intranodal management systems 110) coupled to the respective airborne platforms 108 and the CRM 102, intranodal conveyances 112-1 to 112-n (collectively the intranodal conveyances 112) connected, at least once over a given time span, to the respective airborne platforms 108.

In the example of FIG. 1, the aerostats 106 are intended to represent one or more lighter than air aircraft that use aerostatic lift, a buoyant force that does not require movement through surrounding air, to remain aloft for some amount of time. This contrasts with aerodynes that primarily use aerodynamic lift, requiring the movement of a wing surface through surrounding air. The term aerostat has been used in a narrower sense to refer to a statically tethered balloon in contrast to a free-flying airship; this paper, on the other hand, uses the term aerostat in its broader sense to include airships, which are powered aerostats capable of horizontal flight (e.g., dirigibles), and balloons (tethered or free-flying), which are unpowered aerostats. Airships divide into rigid, semi-rigid, and non-rigid types, with non-rigid types often known as “blimps.” Hybrid airships use both static buoyancy and dynamic airflow to provide lift, and, due to the use of static buoyancy, fall within the definition of “aerostat” as used in this paper. The average density of aerostats is typically lower than the density of atmospheric air because its main component is one or more gasbags, lightweight skins containing a lifting gas to provide buoyancy, to which other components, such as a gondola containing equipment or people, are attached. Buoyant gases can include hot air, helium, hydrogen, coal gas, and low pressure gases (though the latter is currently not considered practical).

In a specific implementation, the aerostats 106 include components that enable the aerostats 106 to float in the air, such as an envelope configured to accommodate buoyant gas. The type of buoyant gas may vary depending upon intended use. For example, it may be considered too dangerous (whether in reality or due to its reputation as an inflammable gas) to use hydrogen when one of the aerostats 106 is implemented at an aerostat node of a passenger transportation network. When hydrogen is employed, the hydrogen can be generated, for example, by electrolysis of water, which can be obtained from the atmosphere (e.g., from rain water or condensation), pumped to the aerostats 106 while the aerostats 106 are airborne, or replenished when the aerostats 106 land. When heated air is employed, the heated air can be obtained by burning fuel, using heat from incident rays of sunlight on components of the aerostats 106 or components attached to the aerostats 106 (potentially using a turbine). In a specific example, a surface of the aerostats 106 has a micro-structure (e.g., mesh structure) to increase a surface area thereof, and heated air around a surface of the aerostats 106 is introduced into the component to provide the floating force, for example, by employing a pump and valve.

In a specific implementation, the aerostats 106 are airships capable of performing flight operations without on-board human piloting; the aerostats 106 may or may not be capable of performing flight operations via remote human piloting, though those without any human piloting are more likely to be tethered balloons than airships. In an implementation in which the aerostats 106 are airships, the aerostats 106 include a thrust unit configured to provide a thrust force to the aerostats 106 to maintain or change to an intended position and orientation, a power unit (e.g., battery, engine, photovoltaic power generator, etc.) configured to provide power to the aerostats 106, and so on. Conceptually, thrusters, power sources, radios (e.g., enabling remote control via a ground-based subsystem), photovoltaic devices, and other hardware can be considered part of the aerostats 106 or the airborne platforms 108, and where the hardware is actually located varies depending upon implementation- and configuration-specific factors, as can any associated software.

In a specific implementation, the airborne platforms 108 do not have a space for payload, all of which is carried by carrier-capable aircraft, zipline baskets, or other devices that follow a path through the aerostat network nodes 104. In other implementations, the airborne platforms 108 include internal or external space for accommodating payload. For example, when the airborne platforms 108 are part of a freight network, the airborne platforms 108 include storage that can be used to store cargo while awaiting pickup, which may further include robotic (or manual) sorting, robotic (or manual) packing of smaller packages into larger containers or vice versa, a conveyer belt, or the like. As another example, when the airborne platforms 108 are part of a passenger transportation network, the airborne platforms 108 include internal or external space in which passengers can await transport. It may be noted, if appropriately configured, passenger modules can also be bundled or unbundled, rather like cargo. As another example, when the airborne platforms 108 are part of a communications network, the airborne platforms 108 may include a persistent datastore; a store-and-forward communications network node that does not include persistent storage will store data at least from the time the data is received to the time the data is sent, but, for the purposes of this example, a buffer of this sort is not considered to be a persistent datastore.

In the example of FIG. 1, the intranodal management systems 110 is intended to represent hardware or software used to control the aerostats 106 and/or components of the airborne platforms 108. In a specific implementation, at least a portion of the intranodal management systems 110 are line-of-sight with the aerostats 106 and can be characterized as including ground-based communications subsystems for sending data and commands to the airborne platforms 108 and receiving data from the airborne platforms 108. In an implementation in which the intranodal management system 110 use a wireless link to communicate with the airborne platforms 108, the intranodal management system 110 and/or the airborne platforms 108 can be referred to as stations.

A station, as used in this paper, can be referred to as a device with a media access control (MAC) address and a physical layer (PHY) interface to a wireless medium that complies with the IEEE 802.11 standard. Thus, for example, the network devices can be referred to as stations, if applicable. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. Wi-Fi is a non-technical description that is generally correlated with the IEEE 802.11 standards, as well as Wi-Fi Protected Access (WPA) and WPA2 security standards, and the Extensible Authentication Protocol (EAP) standard. In alternative embodiments, a station may comply with a different standard than Wi-Fi or IEEE 802.11, may be referred to as something other than a “station,” and may have different interfaces to a wireless or other medium. In an implementation in which the carrier-capable aircraft 106 use a wireless link to communicate with the intranodal management systems 112 and/or the airborne aircraft carriers 102, the carrier-capable aircraft 106 can also be referred to as stations.

The intranodal management systems 110 depicted in the diagram 100 include intranodal aerostat control subsystems 114-1 to 114-n (collectively the intranodal aerostat control systems 114) and intranodal logistics subsystems 116-1 to 116-n (collectively the intranodal logistics subsystems 116). (The intranodal aerostat control subsystems 114-2 to 114-n and the intranodal logistics subsystems 116-2 to 116-n are not depicted in the example of FIG. 1, but are assumed extant.)

In a specific implementation, the intranodal aerostat control subsystems 114 include ground-based wireless control hardware and software used to pilot the aerostats 106. Alternatively or in addition, the intranodal aerostat control subsystems 114 include cloud-based wireless control hardware and software. The intranodal aerostat control subsystems 114 can also receive status and other information from the airborne platforms 108 associated with the location, performance, or other characteristic of the aerostats 106.

In a specific implementation, the intranodal logistics subsystems 116 include ground-based wireless control hardware and software used to manage the internodal conveyances 112 and payloads conveyed thereby. Alternatively or in addition, the intranodal logistics subsystems 116 include cloud-based wireless control hardware and software. The intranodal logistics subsystems 116 can also receive status and other information from the airborne platforms 108 associated with the location, performance, or other characteristic of the internodal conveyances 112 and payload carried thereby.

In a specific implementation, the internodal conveyances 112 include unmanned aerial vehicles (UAVs), commonly known as drones. UAVs are aircraft without a human pilot aboard, though they can carry humans (e.g., passenger drones), and have a degree of autonomy that depends upon implementation- and/or configuration-specific factors (e.g., remote control by a human or artificial agent or autonomously by onboard computers). Some jurisdictions define UAV has having a particular size or weight threshold (though the US Federal Aviation Administration does not rely upon size in the definition), and the definition can vary by jurisdiction; the term drone is more generally applicable. Airships (other than, perhaps, hybrid airships) are sometimes excluded from the definition of UAVs. For the purposes of this paper, it is not particularly important for UAVs to exclude airships, so henceforth in this paper, UAV is intended to be an acronym for “unmanned aircraft vehicle” (as opposed to unmanned aerial vehicle), which, for the avoidance of doubt, is intended to generally include remotely piloted aircraft, including non-hybrid aerostats.

Depending on implementation- and/or configuration-specific factors, the internodal conveyances 112 have a configuration suitable to achieve an intended launch capability. For example, the internodal conveyances 112 can have a body that is transformable to a streamlined or aerodynamically efficient shape, such as a very-low-drag (VLD) bullet shape, in a launch mode for when the internodal conveyances 112 are released by a railgun and an aircraft catapult, and to a glider shape having one or more wings in a flight mode for after the launch mode. Depending on implementation- and/or configuration-specific factors, the internodal conveyances 112 have a configuration suitable to achieve an intended range capability. For example, the internodal conveyances 112 can include a rechargeable battery to generate sufficient power to fly from a non-aerostat intermodal node to a gateway aerostat node of an aerostat network, from a first aerostat node (e.g., a gateway aerostat node, a bridging aerostat node, or some other aerostat node) of an aerostat network to a second aerostat node (e.g., a gateway aerostat node, a bridging aerostat node, or some other aerostat node) of the aerostat network, and/or from a gateway aerostat node to a non-aerostat intermodal node, and to recharge at a node along the path if necessary. In another example, the internodal conveyances 112 include a photovoltaic panel configured to convert solar power to electric power, which can extend the range of the internodal conveyances 112.

In a specific implementation, the internodal conveyances 112 carry payload from a non-aerostat node, such as an intermodal terminal, to the aerostat network node 104-1, which is assumed for illustrative purposes to be an ordinally first node of a path for payload through an aerostat network to the aerostat network node 104-n, which is assumed for illustrative purposes to be an ordinally last node of the path. The internodal conveyance used to carry payload from the non-aerostat node to the aerostat network node 104-1 and the internodal conveyance used to carry payload from the aerostat network node 104-1 to the aerostat network node 104-2 need not be the same. For example, a pully could be used to carry payload to the aerostat network node 104-1 and a drone could be used to carry the payload from the aerostat network node 104-1 to the aerostat network node 104-2.

In a specific implementation, the internodal conveyances 112 have an internal space for accommodating payload. For example, when the internodal conveyances 112 are capable of accommodating cargo (e.g., parcels, luggage's, etc.), the internodal conveyances 112 have a cargo space. In another example, when the internodal conveyances 112 are capable of accommodating passengers, the internodal conveyances 112 have a passenger space. Internodal conveyances 112 can include non-volatile storage to carry the data, though it is not generally described as being stored in an “internal space.”

Instead or in addition, the internodal conveyances 112 can be configured to carry external payload. For example, the internodal conveyances 112 can have a deck space (likely, but not necessarily including a fastening mechanism) or a shackle suitable for attachment to a container that is to be carried by the internodal conveyances 112 in flight. When a first of the internodal conveyances 112 docks, the payload can be transferred directly to a second of the internodal conveyances 112 or to the airborne platforms 108 for further transportation (e.g., to a third of the internodal conveyances 112 and/or to a non-aerostat node).

In an implementation in which payload is electronic data, the internodal conveyances 112 may collect payload in transit while traversing the path. For example, if the internodal conveyances 112 are used for pipeline inspection, the surveillance data collected by the internodal conveyances 112 while in transit between two of the aerostat network nodes 104 comprises payload. Whether data payload can be offloaded in real time depends upon wireless capabilities of the internodal conveyances 112. For example, if the internodal conveyances 112 have no wireless capabilities or have insufficient range to remain in continuous wireless communication with an aerostat network node or the CRM 102, the internodal conveyances 112 may need to offload electronic data payload as a batch when docking or coming within range.

In an implementation in which the airborne platforms 108 can interface with UAVs, the aerostats 106 and airborne platforms 108 can be characterized as airborne aircraft carriers. In an implementation that includes airborne aircraft carriers, payload is conveyed by carrier-based aircraft, which are sometimes referred to as carrier-capable aircraft or carrier-borne aircraft. Carrier-based aircraft can dock in an internal or external bay of the airborne aircraft carrier, be attached via a hook or clip, land on a deck, or use some other mechanism to facilitate carriage by the airborne aircraft carrier. Although the standard term for aircraft that can be carried by an aircraft carrier is “carrier-based aircraft,” the term carrier-capable aircraft is used in this paper to ensure there is no misunderstanding that the aircraft can be carried by the airborne aircraft carrier, but need not be based on any airborne aircraft carrier. For example, a carrier-capable aircraft can be ground-based, but capable of docking on an airborne aircraft carrier to deliver payload, recharge, or for some other purpose. As another example, a carrier-capable aircraft can dock on multiple different airborne aircraft carriers and not be based on any single one of the multiple different airborne aircraft carriers. As used in this paper, docking is intended to encompass carrier-capable aircraft landing on, attaching to, or causing to be carried by an airborne aircraft carrier. Depending upon implementation- and/or configuration-specific factors, the airborne aircraft carriers can take off with or without one or more carrier-capable aircraft.

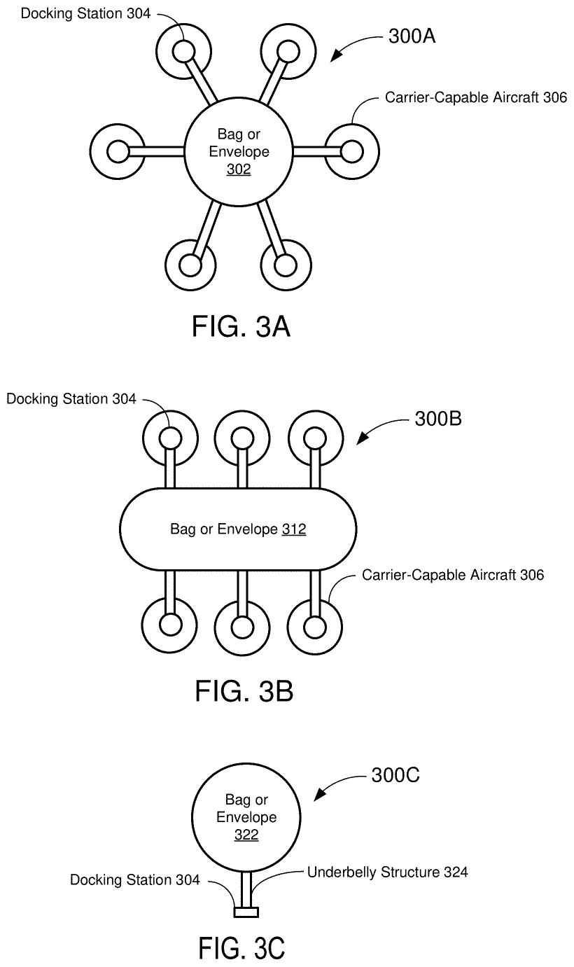

FIGS. 3A and 3B are top view diagrams 300A and 300B of examples of airborne aircraft carriers suitable for use at an aerostat network node; FIG. 3C is a side view diagram 300C. In the example of FIG. 3A, the airborne aircraft carrier includes a bag or envelope 302, which conceptually roughly corresponds to the aerostats 106 depicted by way of example in FIG. 1, docking stations 304, which conceptually would be part of the airborne platforms 108 depicted by way of example in FIG. 1, connected to the bag or envelope 302 via radially extending arms, and carrier-capable aircraft 306, which conceptually correspond to the internodal conveyances 112 depicted by way of example in the example of FIG. 1, at the docking stations 304.

In the example of FIG. 3A, the bag or envelope 302 is depicted as a circle, which represents a relatively spherical bag or envelope of an aerostat. The radially extending arms of the airborne aircraft carrier 300A are depicted as six arms distanced uniformly from one another at about π/3 radians. In this way, the docking stations 304 extend uniformly around the bag or envelope 302. In alternatives, different numbers of arms can extend from the bag or envelope 302. In a specific implementation in which the bag or envelope 302 can be characterized as having arms extending therefrom, the arms can include a path through which payload is moved to internal or external storage of the airborne aircraft carrier 300A from internodal conveyances, or vice-versa.

In the example of FIG. 3A, the docking stations 304 are depicted as circles (intended to represent the top of a hooking device, which is one of many mechanisms that can be used for docking purposes). The docking stations 304 are intended to represent components configured to be detachably operationally coupled to the carrier-capable aircraft 306. When the carrier-capable aircraft 306 are implemented as rotorcraft, rotary wings can generate both lift and a corresponding down draft; down drafts are known to interfere with docking. Advantageously, by causing the carrier-capable aircraft 306 to move up for docking, the docking operation can be carried out more efficiently. Accordingly, the docking stations 304 can include downward-directed components configured to be operationally coupled to a top portion of the carrier-capable aircraft 306.

In a specific implementation, the docking stations 304 have a charging port configured to charge batteries of the carrier-capable aircraft 306. Depending on a specific implementation, an applicable charging port is employed. For example, the charging port can include a wired port (e.g., DC port) configured to be operationally connected to a corresponding charging port of the carrier-capable aircraft 306. In another example, the charging port can include a wireless charging port configured to charge a battery without being physically connected to the carrier-capable aircraft 306.

In a specific implementation, the docking stations 304 include a discharging unit configured to discharge carrier-capable aircraft 306 into the air from the docking stations 304. For example, when the carrier-capable aircraft 306 are assumed to be capable of departing the airborne aircraft carrier 300A with sufficient thrust force generated on its own, the docking stations 304 can include a releasing unit, e.g., a clip, configured to release the coupling of the docking stations 304 and the carrier-capable aircraft 306, such that the released carrier-capable aircraft 306 flies on its own. In another example, when the carrier-capable aircraft 306 is not assumed to have sufficient thrusting force (or to give the carrier-capable aircraft 306 a boost), the docking stations 304 can include a releasing unit, e.g., a railgun or aircraft catapult, that launches the carrier-capable aircraft 306, such that the released (or launched) carrier-capable aircraft 306 can fly on its own.

In the example of FIG. 3B, the bag or envelope 312 of the airborne aircraft carrier is depicted as an elongated (capsule) shape, which represents an elongated bag or envelope. The docking stations extend on either side of an axis in the same plane as the keel of the airship. Other shapes or multiple shapes (associated with multiple bags or envelopes) are possible.

In the example of FIG. 3C, an aerostat bag 322 of the airborne aircraft carrier is depicted as a circle, which could represent a circular bag or envelope or front (or rear) facing of an elongated shape. An underbelly structure 324, which can represent a minimalist structure, such as a pole, or a more complex structure, such as a gondola, (either of which conceptually would be part of the airborne platforms 108 depicted by way of example in FIG. 1) attaches a docking station 304 to the airborne aircraft carrier underneath the bag or envelope 322. Multiple docking stations can be attached relatively symmetrically, along an axis of an elongated bag, in combination with docking stations that extend outward, such as is depicted in the examples of FIGS. 3A and 3B, or in some other applicable configuration.

Referring once again to the example of FIG. 1, the aerostat network management system 120 is intended to represent a system capable of tracking state in the aerostat network and an agent interface. State can include infrastructure assets, such as the state of the aerostats 106, airborne platforms 108, and/or the intranodal conveyances 112 (including location if the intranodal conveyances 112 are mobile) and/or payload, such as the state of cargo or passengers (potentially including cargo or passengers that are scheduled, but not yet in transit). An agent can include human or artificial agents. The agent interface enables an agent to monitor, control, and share information about the infrastructure and payload.

In a specific implementation, the aerostat network management system 120 is implemented in the cloud. However, a persistent centralized implementation and a distributed implementation (including, potentially, distributing portions of the aerostat management system 120 across the intranodal management systems 110) are also possible. The aerostat network management system 120 may or may not be in continuous communication with the aerostat network nodes 104. For example, the aerostat network nodes 104 can have automated instructions, the setting of which can be at least conceptually attributed to the aerostat network management system 120, and run in accordance with node-specific automated procedures.

In an example of operation, the aerostat network management system 120 sets automated procedure parameters for the aerostat network nodes 104. The intranodal aerostat control subsystems 114 transmit instructions to receivers on the airborne platforms 108, which can include persistent storage for automated procedures to reduce the number of control signals that need be transmitted, and the aerostats 106 are piloted as appropriate. Where the aerostats 106 are fixed via a cable or other restraint, altitude control can be ground-based (e.g., at the intranodal management systems 110). The intranodal logistics subsystem 116 transmits instructions directly, or indirectly through the airborne platforms 108, to the internodal conveyances 112, and the internodal conveyances 112 are controlled as appropriate. For example, if the internodal conveyances 112 are transmitters, they transmit electronic data as appropriate to transmit the electronic data from one aerostat node to the next. As another example, if the internodal conveyances 112 are carrier-capable aircraft, they carry payload as appropriate to transport the payload from one aerostat node to the next. If the internodal conveyances 112 are carrier-capable aircraft, the payload can also be collected in transit, such as when the carrier-capable aircraft are used to inspect a pipeline, dike, hillside, or other natural or artificial structure and carry the collected electronic payload to the next aerostat node. Depending upon implementation- and/or configuration-specific factors, the collected electronic payload can also be transmitted in transit.

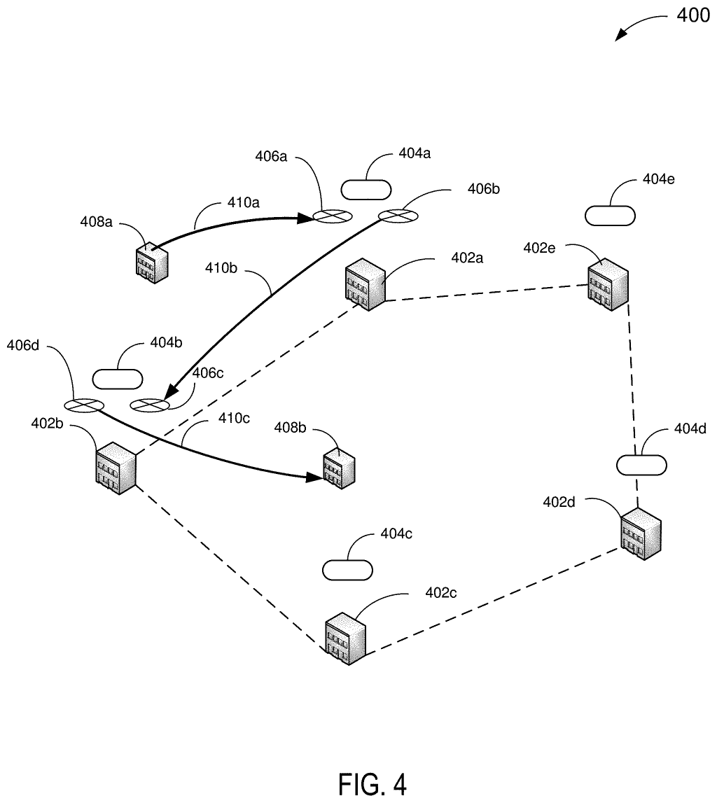

FIG. 4 is a diagram 400 of an example of an aerostat network system with carrier-capable aircraft that travel between aerostat nodes. The example of FIG. 4 is intended to provide a more specific implementation than that of FIG. 1; for illustrative purposes, at least a portion of the aerostat network nodes 104 of FIG. 1 are ground-based (in the example of FIG. 4, the aerostats 106 of FIG. 1 include airborne aircraft carriers, the ground-based portion of the aerostat network nodes 104 are assumed to be at least portions of the intranodal management systems 110 of FIG. 1), and the internodal conveyances 112 of FIG. 1 are carrier-capable aircraft in FIG. 4 and payload is cargo. The diagram 400 includes a plurality of aerostat network ground-based stations 402a-402e (hereinafter collectively referred to as aerostat network ground-based stations 402), a plurality of aerostats 404a-404c (hereinafter collectively referred to as aerostats 404), a plurality of UAVs 406a-406d (hereinafter collectively referred to as UAVs 406), and a plurality of branch stations 408a-408b (hereinafter collectively referred to as branch stations 408).

In the example of FIG. 4, one or more of the aerostat network ground-based stations 402 are intended to represent intranodal infrastructure, such as control consoles, zipline components, cables, winches, or the like. The aerostat network ground-based stations 402 can include part of an aerostat network node (e.g., an intranodal management system, such as a specific implementation of one of the intranodal management systems 110 of FIG. 1).

In the example of FIG. 4, the aerostat network ground-based stations 402a-402e have associated aerostats 404a-404e; each of the aerostat network ground-based stations 402a-402e and each of the associated aerostats 404a-404e, respectively, can be referred to as aerostat gateway nodes. Although the aerostats 404 are depicted in the diagram 400 as singular aerostats, each of the aerostats 404 could be characterize as a set of aerostats in implementations in which aerostat network nodes include a variable (or non-singular) number of aerostats. In a specific implementation, the aerostat network ground-based stations 402 are associated with a set of aerostats, for example, by associating a base station unique identifier with a set of unique aerostat identifiers. The sets of aerostats are airborne above the respective aerostat network ground-based stations 402 when the aerostats are not in transit or grounded (e.g., for repair, maintenance, storage, or the like).

In a specific implementation, one or more of the aerostat network ground base stations 402 are configured to discharge a transformable UAV in a discharge-suitable form (e.g. bullet form), such that the transformable UAV obtains a sufficient thrust force to reach one of the aerostats 404. An applicable mechanism to discharge the transformable UAV, such as a railgun and an aircraft catapult, can be employed. In a specific implementation, the discharged transformable UAV is caught by the targeted aerostat, which may or may not be able to the caught transformable child vehicle toward a destination of the child vehicle. In another specific implementation, after the transformable child vehicle is discharged in the air, the transformable child vehicle transforms to a winged plane form (e.g., glider) and the child vehicle in the winged plane form flies to a destination, such as the aerostat 404.

In the example of FIG. 4, the aerostat 404a is illustrated as having the two UAVs 406a and 406b and the aerostat 404b is illustrated as having the two UAVs 406c and 406c. Other ones of the aerostats 404 may or may not also have UAVs, but they are omitted to avoid cluttering the figure. In an example of operation, the UAVs 406 carry cargo between the branch stations 408a and 408b via the aerostat network.

In the example of FIG. 4, the branch stations 408 are intended to represent non-aerostat nodes. Depending upon implementation- and/or configuration-specific factors, the branch stations 408 can be a warehouse or retail delivery center that is conceptually disconnected from other transportation networks (though, generally, even a conceptually disconnected ground-based node will typically be connected to a local and ultimately global transportation network by, e.g., a road), or the branch stations can be a gateway node to a non-aerostat-based transportation system for transporting, e.g., maritime cargo, air cargo, rail cargo, or road cargo. For example, the branch stations 408 may include one or more of a regional freight collection and delivery center, an airport, a train station, a retailer delivery center, an intermodal terminal, and so on.

Depending upon implementation- and/or configuration-specific parameters, cargo may or may not be unpacked at the branch stations 408 for warehousing, distribution via a retail or wholesale outlet, or even delivery (e.g., from the roof of a consumer of the cargo).

In an implementation in which at least one of the branch stations 408 includes an intermodal terminal, cargo may be conveyed from one transportation network to another using an intermodal container at the branch stations 408. For example, intermodal containers are designed and built for intermodal freight transport, meaning these containers can be used across different modes of transport, such as from ship to rail to truck, without unloading and reloading their cargo. Intermodal container sizes can vary, but about 90% of the current global container fleet are general purpose containers, durable closed steel boxes, mostly of either twenty or forty foot standard length with common heights of 8.5 feet or 9.5 feet (the latter are known as High Cube containers). Intermodal containers share a number of key construction features to withstand the stresses of intermodal shipping, to facilitate their handling and to allow stacking, as well as being identifiable through their individual, unique ISO 6346 reporting mark. International Organization for Standardization (ISO) 6346:1995 is incorporated by reference.

In an implementation in which at least one of the branch stations 408 acts as a bridge node between subnetworks, cargo may be conveyed from a first subnetwork to a second subnetwork using an intermodal container as discussed in the previous paragraph or by reloading cargo at, e.g., a break-bulk facility of the relevant ones of the branch stations 408. For example a first subnetwork of a road transportation network can be traversed by a full truckload (FTL) carrier with cargo filling a semi-trailer, while a second subnetwork of the road transportation network can be traversed by a less than truckload (LTL) carrier; the FTL shipments can be broken down into individual containers (e.g., crates, shrink wrapped pallets, corrugated fiberboard shipping containers, etc.) and transported by the LTL carrier. LTL containers can be intermodal. An alternative to LTL is parcel, which are conveyed by parcel carriers that traditionally handle cargo units of less than approximately 150 pounds. Each subnetwork may or may not have standardized container sizes.

In an implementation in which at least one of the branch stations 408 acts as a gateway node between networks, cargo may be conveyed from a first network to a second network using an intermodal container as discussed in the previous paragraphs or by reloading cargo at, e.g., a break-bulk facility of the relevant ones of the branch stations 408. For example a road network of a transportation supernetwork can be traversed by a road haulage vehicle, such as a semi truck or a van, while the aerostat network, such as is illustrated in the example of FIG. 4, of the transportation supernetwork can be traversed by carrier-capable aircraft. Each network may or may not have standardized container sizes.

Although the branch stations 408 and the aerostat network ground-based station 402a are depicted as having different geolocations, if implemented appropriately, one or more of the aerostat network ground-based stations 402 can share a geolocation with one, some, or all of the branch stations 408. In such an implementation, relevant ones of the aerostat network nodes can be characterized as first gateway nodes and relevant ones of the non-aerostat network nodes can also be characterized as second gateway nodes, or the first and second gateway nodes can simply be characterized as shared gateway nodes. Because shared gateway nodes as illustrated in the figures always share with an aerostat network, shared gateway nodes are assumed to be aerostat network nodes in this paper. Moreover, even in instances where one or more of the branch stations 408 are geographically separated from the aerostat network ground-based stations 402, the branch stations 408 and the relevant aerostat node can be characterized as a geographically distributed shared gateway node.

In some embodiment, the one or more of the branch stations 408 are configured to allow aircraft (e.g., aerostats 404 and/or UAVs 406) to land based on a flight schedule. For example, the branch station 408a can guide UAV 406a to a designated landing location as illustrated in the diagram 400 by the arrow 412a and the branch station 408b can guide UAV 406b to a designated landing location as illustrated in the diagram 400 by the arrow 412b. In the diagram 400, there is no arrow representing landing of any of the aerostats 404, which may or may not be included in the functionality of the illustrated system.

In an example of operation, an aerostat-based transportation system such as is illustrated in FIG. 4 operates as follows. Prior to start of service by the aerostat-based transportation system, aerostats 404 take off from the aerostat network ground-based stations 402 or some other location and are elevated and/or piloted to a location near (in some implementations, directly above) the aerostat network ground-based stations 402, where they remain to provide a relatively static aerostat network node configuration. The UAVs 406 are carried aloft by the aerostats 404, launched from a platform not on an aerostat (such as the aerostat network ground-based stations 402), or some combination thereof.

In this example of operation, a non-aerostat-based transportation system (e.g., a first truck) delivers cargo to the branch station 408a, where it is picked up by the UAV 406a. The cargo can be delivered in an intermodal container that is carried as is by the UAV 406a, delivered in a super-container (i.e., a container larger than that used by the aerostat network) and divided into standardized, proprietary, or other-sized containers that can be carried by at least the UAV 406a (referred to hereinafter as aerostat network containers, which may or may not include different sizes and may or may not be different across aerostat subnetworks), delivered in smaller containers or parcels that are combined into aerostat network containers, or delivered as or broken into parcels.

In this example of operation, the UAV 406a is dispatched from the aerostat 404a, some other aerostat, or a non-aerostat location; or the UAV 406a may be located at the branch station 408a because the branch station 408a includes a non-aerostat docking station for the UAV 406a or the UAV 406a dropped off cargo prior to picking up the new cargo. In a specific implementation, an integrated intermodal logistics engine determines when the UAV 406a should be dispatched to the branch station 408a and/or depart from the branch station 408a. The intermodal logistics engine ideally knows the state of cargo relative to the network infrastructure and can maximize characteristics of the network, such as throughput, quality of service, or the like, using the information.

In this example of operation, the cargo is carried by the UAV 406a from the branch station 408a to the aerostat 404a along a path that is conceptually illustrated in the diagram 400 with the arrow 410a. While only a single UAV 406a is depicted in the diagram 400, a first UAV can be used to carry a first portion of cargo along the path and a second UAV can be used to carry a second portion of cargo along the path. Similarly, the UAV 406a or multiple UAVs can travel back-and-forth along the path to carry the cargo, with or without carrying cargo or empty aerostat network containers in the opposite direction (i.e., from the aerostat 404a to the branch station 408a). Not all cargo delivered to the branch station 408a need be carried by the UAV 406a. For example, a first portion of cargo could be loaded onto a van for ground-based delivery and a second portion of cargo could be carried by the UAV 406a.

In this example of operation, the UAV 406a docks at the aerostat 404a. The UAV 406a may dock to recharge and then take off as UAV 406b (i.e., the UAV 406a and 406b may be the same UAV, where the former is prior to recharge and the latter is recharged). Alternatively, the cargo carried by the UAV 406a is conveyed to the UAV 408b while the UAV 406a is recharging or because the UAV 406b has characteristics that make it more desirable for traversal along the path illustrated as arrow 410b (e.g., it is larger (potentially consolidating cargo from multiple different branch stations), is smaller (potentially breaking cargo into smaller portions at the aerostat 404a), has greater endurance/range, has less endurance/range (potentially making it cheaper), can carry more cargo, can carry less cargo (potentially making it cheaper), or the like. Where cargo is separated, consolidated, or otherwise moved from the UAV 406a to the UAV 406b, the aerostat 404a will likely include robotic arms, conveyor belts, or the like to accomplish the tasks, as discussed previously with reference to FIG. 1.

In this example of operation, the arrow 410b can include multiple hops (not shown) that culminate in the arrival of the UAV 406c at the aerostat 404b. Where the arrow 410b represents a single hop, the UAV 406c and the UAV 406b are the same UAV. Where the arrow 410b represents multiple hops, the UAV 406c and the UAV 406b may or may not be the same UAV. As described in the previous paragraph, the UAV 406c may or may not convey cargo to the UAV 406d; if no cargo is conveyed between UAVs at the aerostat 404b, the UAV 406c and the UAV 406d are the same UAV.

In this example of operation, arrow 410c represents a path for cargo out of the aerostat network. The branch station 408b can represent a first node of a subnetwork or a final destination.

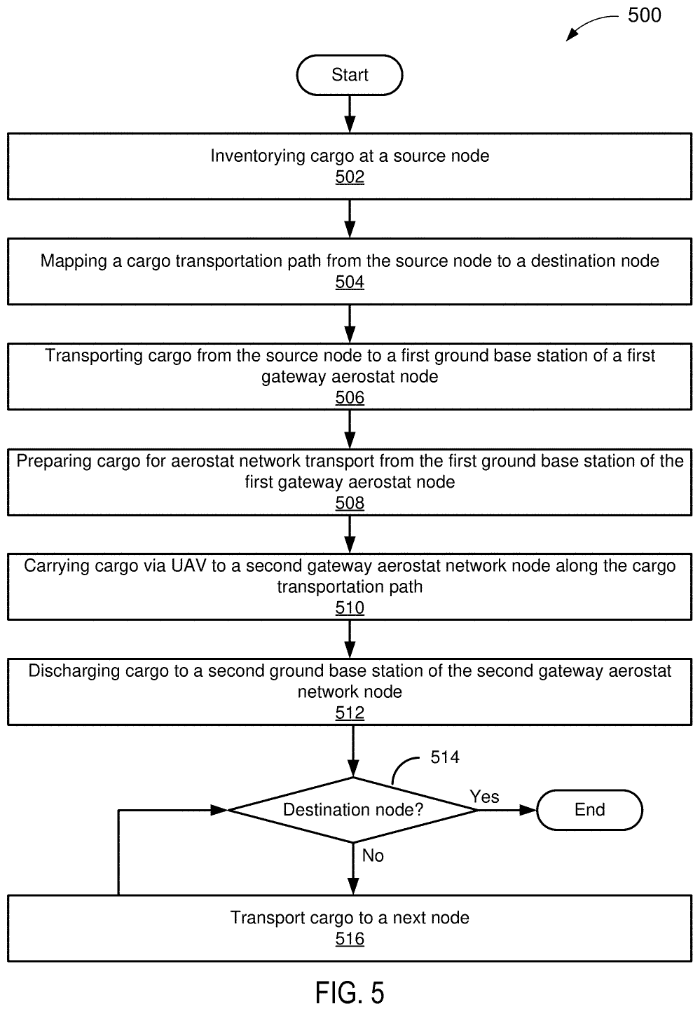

FIG. 5 is a flowchart 500 of an example of a method for payload transportation using an aerostat network with carrier-capable aircraft that travel between aerostat nodes. This flowchart is organized in a fashion that is conducive to understanding. It should be recognized, however, that the modules can be reorganized for parallel execution, reordered, modified (changed, removed, or augmented), where circumstances permit.

In the example of FIG. 5, the flowchart 500 starts at module 502 with inventorying cargo at a source node. Inventorying cargo can include affixing a physical indicator, such as a bar code, or an electronic indicator, such as an RFID. In a specific implementation, when cargo is inventoried at a source node, a cargo ID is stored in a cargo inventory datastore. Inventorying cargo may or may not include identifying a first network node at which cargo enters a transportation network prior to reaching a first gateway aerostat network node. The cargo inventory datastore can also be made accessible at a destination node to enable an update regarding delivery of the cargo. The inventorying of cargo may or may not include identifying a second network node at which cargo leaves a transportation network after the second gateway aerostat network node. The cargo inventory datastore may or may not also be made accessible at various points along a transportation path and can include feedback from a recipient (e.g., to indicate the cargo was received or was not received by the intended recipient).

In the example of FIG. 5, the flowchart 500 continues to module 504 with mapping a cargo transportation path from a source node to a destination node. In a specific implementation, the source node is a first gateway aerostat network node, but it should be understood the mapping can occur prior to cargo being received at the first gateway aerostat network node. Accordingly, the transportation path can include either an aerostat network or a hybrid aerostat network that includes non-aerostat networks. Also, mapping can occur in stages such that mapping is done from a non-aerostat source node to a non-aerostat destination node through an aerostat network, which is treated as a black box, and mapping is also done by an aerostat network management system from a first gateway aerostat network node to a second gateway aerostat network node.

The mapping can be relatively trivial for an aerostat network topology with the aerostat nodes arranged in series because there is only one path. The mapping can be relatively complex by traversing a mesh-like topology, tracking available infrastructure assets, maximizing transportation parameters (e.g., throughput, frequency of meeting quality of service thresholds, honoring reservations, energy conservation, cost savings, infrastructure asset useful life estimates, etc.) and taking into account various factors that impact transportation of cargo, such as cargo size and/or weight, distance to destination, time to destination, energy consumption to move cargo, air/ground/water traffic conditions, weather conditions, local regulation compliance, etc.

In the example of FIG. 5, the flowchart 500 continues to module 506 with transporting cargo from the source node to a first ground base station of a first gateway aerostat node. Where the source node is a non-aerostat node, the cargo enters the transportation network earlier, making the transportation network a hybrid aerostat transportation network, and is transported potentially great distances over a non-aerostat transportation network to the first ground base station of the first gateway aerostat node.

In the example of FIG. 5, the flowchart 500 continues to module 508 with preparing cargo for aerostat network transport from the first ground base station of the first gateway aerostat node. Cargo can be loaded in a manner that is consistent with intermodal container loading, a break-bulk process, or the like. Depending upon implementation- and/or configuration-specific factors, the cargo may be containerized in an aerostat network container, which may or may not be an intermodal container, or in parcels, including, for example, container-less packages. The loading can be manual, by robotic arm, or by conveyor belt, to name three of many possibilities. The cargo can also be physically or electronically labeled, if adequate labeling was not affixed or associated with the cargo prior to reaching the first gateway aerostat network node. (See module 502.) In a specific implementation, preparing cargo for aerostat network transport includes loading a UAV with the cargo, which may or may not make a stop at a first aerostat of the first gateway aerostat node on its way to a second aerostat. Alternatively, the cargo can be elevated to a first aerostat using a winch, zipline, or the like, and then loaded onto a UAV at the first aerostat.

In the example of FIG. 5, the flowchart 500 continues to module 510 with carrying cargo via UAV to a second gateway aerostat node along the cargo transportation path. In a specific implementation, the UAV first flies to a first aerostat of the first gateway aerostat node without external assistance (e.g., by lifting off under its own power and flying to the first aerostat). Carrying the cargo to the first aerostat can, instead or in addition, include launching the UAV with a catapult or railgun. When the UAV reaches the first aerostat, the UAV can recharge in preparation for a next leg of the cargo transportation path or the cargo can be loaded into a different UAV that will carry the cargo on the next leg. Container loading and break-bulk may or may not also be performed at the first aerostat. Alternatively, cargo can be provided to the first aerostat by having the UAV land nearby and provide cargo to the aerostat via a zipline, or through some other applicable mechanism. The UAV may or may not stop at intermediate aerostat nodes for break-bulk, recharging, transfer of cargo to a different UAV, etc., on its way to the second gateway aerostat network node.

In the example of FIG. 5, the flowchart 500 continues to module 512 with discharging cargo to a second ground base station of the second gateway aerostat node. In a specific implementation, a UAV docks at a second aerostat of the second gateway aerostat node and the cargo is carried to the second base station after the UAV recharges, by a different UAV, or via a winch, zipline, railgun, or the like. Alternatively, an incoming UAV can fly directly to the second ground base station. Depending upon implementation- and/or configuration-specific factors, the arriving UAV can be stored for batch pickup, dock at the second ground base station, dock at a second aerostat of the second gateway aerostat node, be loaded with new cargo, or the like.

In the example of FIG. 5, the flowchart 500 continues to decision point 514 with determining whether the cargo has reached the destination node. Depending upon whether there is a next node, break-bulk, containerization, or the like can occur at the second ground base station. If it is determined the cargo has reached the destination node (514—Yes), then the flowchart 500 ends. If, on the other hand, it is determined the cargo has not reached the destination node (514—No), then the flowchart 500 continues to module 516 with transporting cargo to a next node. The next node can be an interim destination along a transportation path, an interim destination of a supply chain (e.g., at a retail or wholesale warehouse), or the destination node (e.g., at a consumer rooftop). A node that is not a final destination cargo may still be treated as a destination node if an aerostat network management system hands responsibility for cargo transportation off to some other entity. Break-bulk, containerization, or the like can occur at each next node or a subset thereof. Decision point 514 and module 516 form a loop that repeats until the next destination is the final destination (514—Yes).

In an implementation in which the cargo is not unloaded from the UAV at a destination, cargo can be loaded onto, e.g., a ground transportation vehicle, such as a self-driving vehicle. In this paper, “self-driving vehicle” is intended to represent a vehicle that is capable of driving (e.g., accessing, braking, turning, etc.) without real time human inputs or with limited real time human inputs for movement of the vehicle. It is also conceivable for cargo to be transported to another aerostat network, where it is loaded onto a UAV, transported, and unloaded at a next destination.

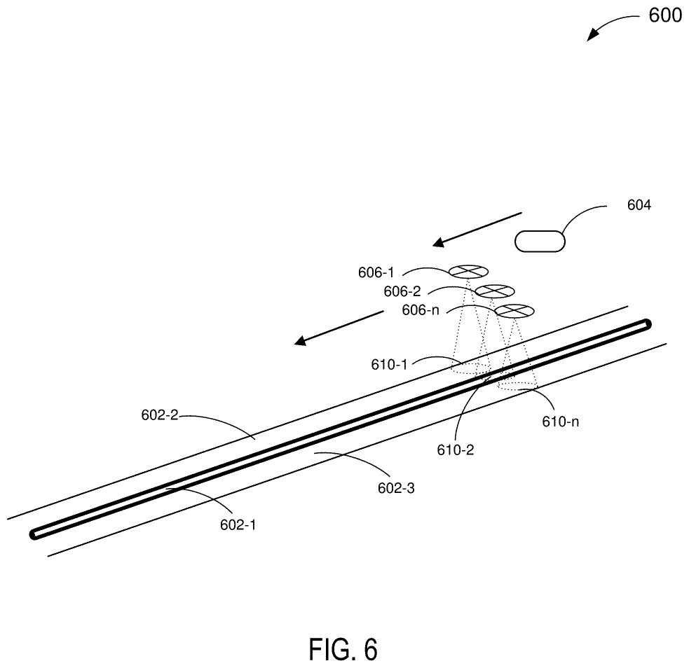

FIG. 6 is a diagram 600 of an example of a mobile aerostat node with carrier-capable surveillance aircraft. The diagram 600 includes a monitored region 602 (comprising, for illustrative purposes, a pipeline 602-1 and right-of-way regions 602-2 and 602-3 on either side of the pipeline), an aerostat 604, and carrier-capable surveillance aircraft 606-1 to carrier-capable surveillance aircraft 606-n (collectively, carrier-capable surveillance aircraft 606). It may be noted that while the monitored region appears to utilize three carrier-capable aircraft, the number can be smaller (as small as one) or larger depending upon the size of the monitored region and the number of passes that are possible for a set of carrier-capable surveillance aircraft over a given period of time. In a specific implementation, the aerostat 604 is part of an aerostat node, such as was described previously with reference to FIG. 1 (see, e.g., aerostat network nodes 104) and the carrier-capable surveillance aircraft 606 are part of an internodal conveyances, such as was described previously with reference to FIG. 1 (see, e.g., internodal conveyances 112).

In the example of FIG. 6, the monitored region 602 is intended to represent a target of an aerostat-based surveillance system. In some embodiments, the monitored region 602 includes a still physical object such as a pipeline, a border wall, a railway, powerlines, canals, etc., and a movable object such as a convoy of ground vehicles, a train, a line of people, a mass of wildlife, etc. In an embodiment in which a pipeline is monitored, nonconformity with a baseline, such as breakage, leak, and unauthorized tampering can be detected through the monitoring. In an embodiment in which a convoy is monitored, increasingly large separation, defections, and interruptions can be detected through monitoring.

In the example of FIG. 6, the monitored region 602 includes right-of-way regions 602-2 and 602-3 that extend away from a pipeline 602-1 on opposite sides thereof. Monitoring the right-of-way regions 602-2 and 602-3 may be desirable to ensure clearance around the pipeline 602-1 and to detect interference (e.g., unauthorized tampering). Monitored regions may or may not have right-of-way regions or may have right-of-way regions on only one side. For example, a border wall might have a right-of-way region on only one side of the wall (or the right-of way region may extend farther on one side of the wall than the other).

In the example of FIG. 6, the aerostat 604 is intended to represent an airborne aircraft carrier and surveillance platform with net-zero energy consumption to enable extended deployments. It should be understood, in several aspects, the aerostat 604 can be treated as a mobile aerostat node that is similar to aerostat nodes described elsewhere in this paper in association with transportation of cargo, but payload is electronic data (e.g., electronic surveillance data) instead of cargo. In a specific implementation, the aerostat 604 serves as a charging station of the carrier-capable surveillance aircraft 606. To serve as a charging station, in some embodiments, the aerostat 604 has an applicable charging port, wired or wireless charging, to which the carrier-capable surveillance aircraft 606 are coupled for charging. The aerostat 604 stays or moves to applicable position(s) for monitoring purpose and/or charging purposes. For example, the aerostat 604 may wait in the air at a predetermined location, such as a start point of the monitoring, for the carrier-capable surveillance aircraft 606 to perform one or more passes over the monitored region 602. In another example, the aerostat 604 trails the carrier-capable surveillance aircraft 606, such that the carrier-capable surveillance aircraft 606 are not apart from the aerostat 604 more than a certain distance. The aerostat 604 may lead the carrier-capable surveillance aircraft 606 in some implementations, and may fly alongside (or with) the carrier-capable surveillance aircraft 606 in other implementations. In some embodiments, the aerostat 604 itself performs monitoring along with the carrier-capable surveillance aircraft 606.

In the example of FIG. 6, the carrier-capable surveillance aircraft 606 are intended to represent vehicles that perform surveillance operations over the monitored region 602. In a specific implementation, at least one of the carrier-capable surveillance aircraft 606 is configured to perform surveillance operations primarily over only one of the right-of-way regions 602-2 or 602-3. For example, the carrier-capable surveillance aircraft 606-1 may perform surveillance operations primarily over the right-of-way region 602-2 while the carrier-capable surveillance aircraft 606-2 may perform surveillance operations primarily over the pipeline 602-1. Depending upon configuration- or implementation-specific factors, the carrier-capable surveillance aircraft 606 may fly along applicable routes for complimentary surveillance purposes. For example, the carrier-capable surveillance aircraft 606-2 may fly directly above the pipeline 602-1 and capture images to either side of the pipeline 602-1 (potentially extending into the right-of-way regions 602-2 and 602-3) and the carrier-capable surveillance aircraft 606-1 may fly directly above the right-of-way region 602-2 and capture images of the pipeline 606-1 at an angle that the carrier-capable surveillance aircraft 606-2 may not have captured. Depending upon configuration- or implementation-specific factors, one of the carrier-capable surveillance aircraft 606 may fly along multi-directional routes surveillance purposes. For example, the carrier-capable surveillance aircraft 606-1 could fly as indicated by way of example in the diagram 600, but fly back along the path attributable to the carrier-capable surveillance aircraft 606-2, and then fly along the path attributable to the carrier-capable surveillance aircraft 606-n (replacing the carrier capable aircraft 606-2 to 606-n with a single aircraft; the aerostat 604 may or may not advance to a next portion of the monitored region 602 while the one or more carrier-capable surveillance aircraft 606 are docked for recharging.

In a specific implementation, when power state of the carrier-capable surveillance aircraft 606 reaches a time-to-dock threshold, the carrier-capable surveillance aircraft 606 proceed to the aerostat 604 for charging and leave the aerostat 604 when power state of the carrier-capable surveillance aircraft 606 reaches a time-to-deploy threshold. The timing to proceed to and leave the aerostat 604 may be different among the carrier-capable surveillance aircraft 606 depending on environmental conditions or deployment parameters. For example, the time-to-dock threshold may be associated with a flat battery life value (e.g., 10%), a dynamic minimum charge (e.g., one that varies by distance from the aerostat 604 or an alternative docking station or for a route that can be completed before a battery is depleted), or some other parameter. As another example, the time-to-deploy threshold may be associated with a flat battery life value (e.g., 100%), a dynamic acceptable charge (e.g., one that varies by route duration, speed, etc.), or some other parameter.

At the start of a mission, the carrier-capable surveillance aircraft 606 may initially take off together with the aerostat 604, coupled to the aerostat 604, or independently from the aerostat 604. At the end of a mission, the carrier-capable surveillance aircraft 606 may land together with the aerostat 604, coupled to the aerostat 604, or independently from the aerostat 604. The take-off location and the landing location may be the same or different. Also, the take-off location and the landing location may be different among the various carrier-capable surveillance aircraft 606 and between the carrier-capable surveillance aircraft 606 and the aerostat 604. It may be noted there could conceivably be, for practical purposes, no end of mission for an aerostat that is capable of net-zero energy consumption. It should be understood, in several aspects, the carrier-capable surveillance aircraft 606 are essentially the same as cargo-carrying carrier-capable aircraft that have electronic surveillance data as payload instead of cargo.

In the example of FIG. 6, the field of capture 610-1 (of the carrier-capable surveillance aircraft 606-1), the field of capture 610-2 (of the carrier-capable surveillance aircraft 606-2), and the field of capture 610-n (of the carrier-capable surveillance aircraft 606-n) (collectively, the fields of capture 610) are intended to represent sub-regions of the monitored region 602 in which sensors are or have previously detected stimuli. In some embodiments, the fields of capture 610 may include partial or complete overlap therebetween. In a specific implementation, 2D images of visible light, and/or images of IR light may be captured within the fields of capture 610; when the sensors are entirely used to detect EM radiation, the fields of capture can be referred to as fields of view. Further, when the 2-D images are captured within adjacent fields of capture, 3D images may be generated based on the captured 2D images, employing applicable 3D rendering technology. Alternatively or in addition, audio (sound) and/or temperature may be detected within the fields of capture 610.

In an example of operation, upon start of mission, the aerostat 604 takes off from a ground base station with the carrier-capable surveillance aircraft 606 coupled thereto and proceeds to a predetermined starting position in the air. When the aerostat 604 reaches the starting position, the carrier-capable surveillance aircraft 606 are deployed from the aerostat 604. The carrier-capable surveillance aircraft 606 proceed to respective positions and follow a route (flight plan) while monitoring a target, while the aerostat 604 follows the carrier-capable surveillance aircraft 606. When remaining power of one of the carrier-capable surveillance aircraft 606 reaches a time-to-dock threshold, one or more of the carrier-capable surveillance aircraft 606 pause their monitoring of a target and return to the aerostat 604 for charging. When power of one or more of the carrier-capable surveillance aircraft 606 reaches a time-to-deploy threshold, one or more of the carrier-capable surveillance aircraft 606 depart the aerostat 604, return to the place at which monitoring was paused, and resume monitoring. When one of the carrier-capable surveillance aircraft 606 completes an intended inspection, one or more of the carrier-capable surveillance aircraft 606 return to the aerostat 604. The process continues until end of mission, when a predetermined number (e.g., all) of the carrier-capable surveillance aircraft 606 return to the aerostat 604, the aerostat 604 proceeds to a predetermined end-of-mission position (such as a ground base station where maintenance can be performed) to await a next mission.

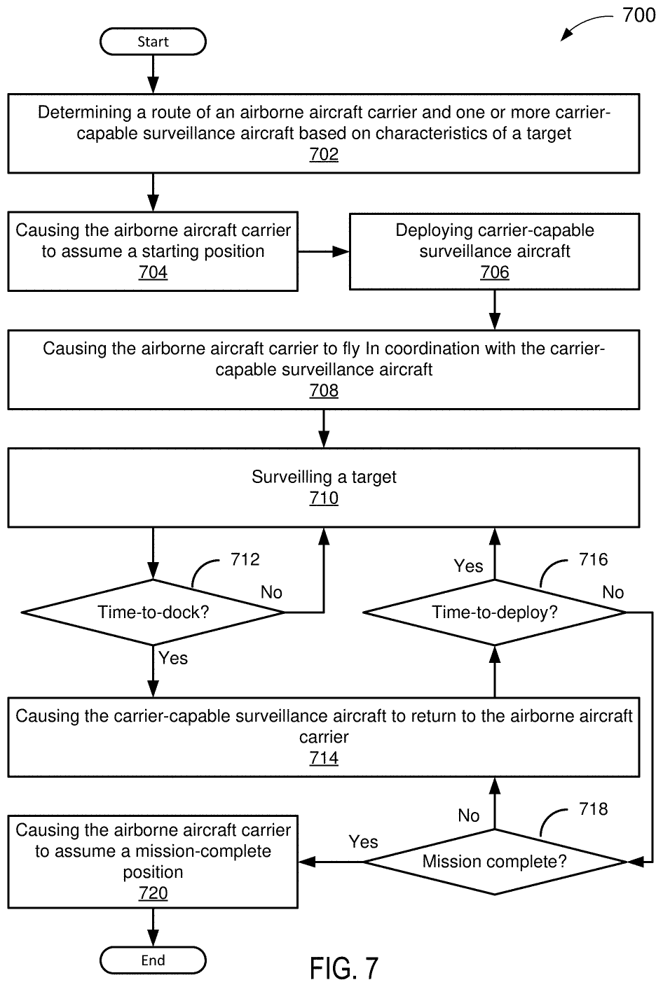

FIG. 7 is a flowchart 700 of an example of a method for conducting surveillance of a target using a mobile aerostat node. In this example, the target includes a monitored region and the mobile aerostat node includes an airborne aircraft carrier. The flowchart 700 starts at module 702, with determining a route of an airborne aircraft carrier and one or more carrier-capable surveillance aircraft based on characteristics of a target. In some embodiments, the route of the airborne aircraft carrier and the carrier-capable surveillance aircraft are determined based on various applicable parameters such as a global position (e.g., latitude and longitude), range of the target, size of the target, mobility of the target, and weather conditions (e.g., wind, sunlight intensity, precipitation, visibility, etc.). In a specific implementation, the route of the carrier-capable surveillance aircraft are dynamically modified based on results of the monitoring. For example, when a non-conformity is found in or near a target, the route of the carrier-capable surveillance aircraft may be modified so as to repeatedly cover the non-conformity to provide more data about the non-conformity. An example of an airborne aircraft carrier is the aerostat 604 (FIG. 6) and examples of the carrier-capable surveillance aircraft are the carrier-capable surveillance aircraft 606 (FIG. 6). See also, FIG. 4.

In the example of FIG. 7, the flowchart 700 continues to module 704 with causing the airborne aircraft carrier to assume a starting position. In a specific implementation, assuming the starting position entails taking off with docked carrier-capable surveillance aircraft and moving at least vertically, but potentially also laterally, to a predetermined aerial starting position. Alternatively, the carrier-capable surveillance aircraft can take off on their own or be launched separately from the airborne aircraft carrier.

In the example of FIG. 7, the flowchart 700 continues to module 706 with deploying the carrier-capable surveillance aircraft. The route of the carrier-capable surveillance aircraft can be computed at any time prior to deployment and provided to the carrier-capable surveillance aircraft any time thereafter. For example, the carrier-capable surveillance aircraft programmed before the start of a mission, at start-of-mission, while docked at the airborne aircraft carrier, or at some other time. Moreover, the route can be dynamically altered as information is obtained about a target, environmental conditions, or the like. The flight plan of the carrier-capable surveillance aircraft will also typically include surveillance instructions, which may include continuous feed, store and forward, store for batch processing, discrete capture (e.g., snapshot), or the like. Surveillance instructions can also be altered dynamically, such as when power is lower for one of the carrier-capable surveillance aircraft, but not others, and the low-power carrier-capable surveillance aircraft switch from continuous feed to discrete capture or from store-and-forward to store for batch processing.

In the example of FIG. 7, the flowchart 700 continues to module 708 with causing the airborne aircraft carrier to fly in coordination with the carrier-capable surveillance aircraft. In a specific implementation, the airborne aircraft carrier follows the carrier-capable surveillance aircraft over a monitored region that has already been monitored in accordance with mission parameters, thereby obviating the need of the carrier-capable surveillance aircraft to traverse the monitored region again to reach the airborne aircraft carrier. In an implementation in which the airborne aircraft carrier is also capable of surveillance, the airborne aircraft carrier can also perform the final sweep of a monitored region as it moves in the direction of deployed carrier-capable surveillance aircraft. In a specific implementation, the airborne aircraft carrier leads the carrier-capable surveillance aircraft to detect dynamically-changing flight conditions, which can be used to modify the route of the carrier-capable surveillance aircraft. In an implementation in which wireless recharging is used, the airborne aircraft carrier can fly within wireless recharge range of the carrier-capable surveillance aircraft for a continuous recharging capability (though this is not necessarily enough to prevent an occasional docking to recharge, depending upon the capabilities of the system).

In the example of FIG. 7, the flowchart 700 continues to module 710 with surveilling a target. Surveilling a target may or may not include surveilling regions near the target, such as right-of-way regions of a (target) pipeline. In a specific implementation, a subplurality of carrier-capable surveillance aircraft may be responsible for the same target, route, or mission, such that when a first of the subplurality is docked, a second of the subplurality is deployed; when the second of the subplurality is docked, the first of the subplurality is deployed. A similar approach may be taken to have one of the subplurality docked while two are deployed, two of the subplurality deployed while one is docked, etc., depending upon the time it takes to recharge or other considerations.

In the example of FIG. 7, the flowchart 700 continues to decision point 712 with determining whether a carrier-capable surveillance aircraft has reached a time-to-dock threshold. If it is determined a time-to-dock threshold has not been reached (712—No), the flowchart 700 returns to module 710 and continues as described previously. If, on the other hand, it is determined a time-to-dock threshold has been reached (712—Yes), the flowchart 700 continues to module 714 with causing the carrier capable surveillance aircraft to return to the airborne aircraft carrier until such time as a time-to-deploy threshold is reached (e.g., after recharging) or the mission ends. During the return to the airborne aircraft carrier, surveillance may or may not continue.

In the example of FIG. 7, the flowchart 700 continues to decision point 716 with determining whether a carrier-capable surveillance aircraft has reached a time-to-deploy threshold. If it is determined a time-to-deploy threshold has been reached (716—Yes), the flowchart 700 returns to module 710 and continues as described previously. If, on the other hand, it is determined a time-to-deploy threshold has not been reached (716—No), the flowchart 700 continues to decision point 718 where it is determined whether the mission is complete. If it is determined the mission is not complete (718—No), the flowchart returns to module 714 and continues as described previously. If, on the other hand, it is determined the mission is complete (718—Yes), the flowchart continues to module 720 with causing the airborne aircraft carrier to proceed to a mission-complete location. In a specific implementation, the mission-complete location is the same as the starting position.

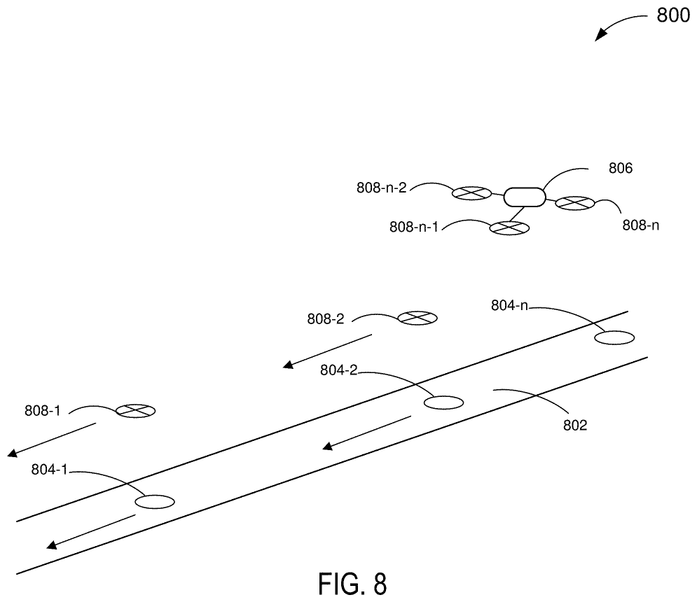

FIG. 8 is a diagram 800 of an example of a mobile aerostat node with carrier-capable surveillance aircraft. FIG. 8 is intended to illustrate a variation on the system described in association with FIG. 6; specifically, for illustrative purposes, more emphasis is placed on a mobile (sub-)target and an aerostat node that is stationary once it is moved into position. The diagram 800 includes a target path 802, a mobile target 804-1 to 804-n (collectively, the mobile targets 804), an aerostat 806, a carrier-capable surveillance aircraft 808-1 to carrier-capable surveillance aircraft 808-n (collectively, the carrier-capable surveillance aircraft 808). In a specific implementation, the aerostat 806 is part of an aerostat node, such as was described previously with reference to FIG. 1 (see, e.g., aerostat network nodes 104) and the carrier-capable surveillance aircraft 808 are part of an internodal conveyances, such as was described previously with reference to FIG. 1 (see, e.g., internodal conveyances 112). See also, aerostat 604 (FIG. 6) and carrier-capable surveillance aircraft 606 (FIG. 6).

In the example of FIG. 8, the target path 802 is intended to represent a path along or in which the mobile targets 804 move. In some embodiments, the target path 802 is on the ground, such as paved roads, unpaved roads, courses of sports events (e.g., ski, snowboard, bike, etc.), and so on; on water, such as river, lake, sea; or in the air. Depending upon implementation- and/or configuration-specific factors, the target path 802 may or may not be a dynamic path that grows or morphs to include any path taken by one or more of the mobile targets 804.

In the example of FIG. 8, the mobile targets 804 are intended to represent animals (including humans) or mobile objects such as automobiles, trains, persons, animals, etc., and groups, formations, or herds thereof. For example, a cyclist in a bicycle race can be a mobile target or a herd of cattle can be a mobile target.

In the example of FIG. 8, the aerostat 806 is intended to represent an airborne aircraft carrier. In a specific implementation, the aerostat 806 serves as a charging station of the carrier-capable surveillance aircraft 808. Multiple aerostats (not shown) can be deployed to enable any of the carrier-capable surveillance aircraft 808 to dock at a nearest available aerostat when needed.

In the example of FIG. 8, the carrier-capable surveillance aircraft 808 are intended to represent vehicles that surveil the mobile targets 804. In a more specific implementation of the embodiments, one or more of the carrier-capable surveillance aircraft 808 is configured to perform monitoring of one of the mobile targets 804. For example, as is suggested by depicting the carrier-capable surveillance aircraft 808-1 above the mobile target 804-1 in the diagram 800, the carrier-capable surveillance aircraft 808-1 monitors the mobile target 804-1 as it moves along the target path 802, the carrier-capable surveillance aircraft 808-2 monitors the mobile target 804-2 as it moves along the target path 802, and the aerostat 806 monitors the mobile target 804-n (or one of the carrier-capable surveillance aircraft 808 could be deployed to monitor the mobile target 804-n). The carrier-capable surveillance aircraft 808-n−2, 808-n−1, and 808-n, if any, are recharging or are otherwise on standby at the aerostat 806.

In an example of operation, the aerostat 806 takes off from a ground station with the carrier-capable surveillance aircraft 808 and proceeds to a predetermined starting position in the air. When the aerostat 806 reaches the starting position, the carrier-capable surveillance aircraft 808 are deployed to monitor the mobile targets 804, some of which may be monitored by a dedicated one of the carrier-capable surveillance aircraft 808 (e.g., leaders or famous participants might be subjected to continuous monitoring) or the carrier-capable surveillance aircraft 808 can switch between mobile targets 804 as is deemed appropriate. When the carrier-capable surveillance aircraft 808 reach a time-to-dock threshold, they can dock at the aerostat 806 (or at some other docking location). When the mission is complete, such as when a race ends, any of the carrier-capable surveillance aircraft 808 that are still deployed return to dock at the aerostat 806 (or at some other docking location).

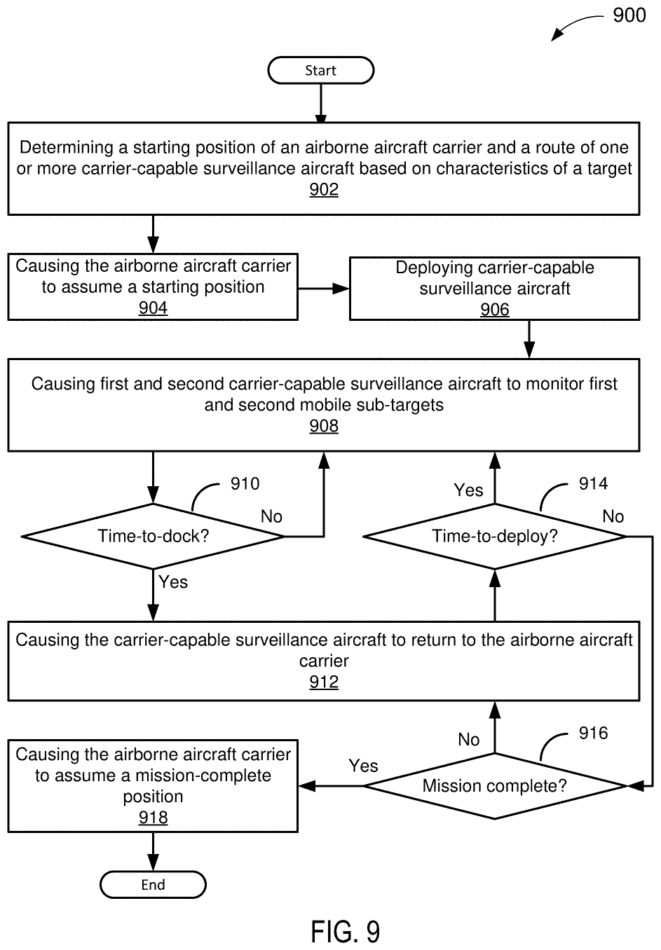

FIG. 9 is a flowchart 900 of an example of a method for conducting surveillance of a target using an aerostat node. In this example, the target includes a mobile (sub-)target and the aerostat node includes an airborne aircraft carrier. FIG. 9 is intended to illustrate a variation on the method described in association with FIG. 7; specifically, for illustrative purposes, more emphasis is placed on a mobile (sub-)target and an aerostat node that is stationary once it is moved into position. The flowchart 900 starts at module 902, with determining a starting position of an airborne aircraft carrier and a route one or more carrier-capable surveillance aircraft based on characteristics of a target. In some embodiments, the starting position of the airborne aircraft carrier and the carrier-capable surveillance aircraft are determined based on various applicable parameters such as a global position (e.g., latitude and longitude), range of the target, size of the target, mobility of the target, weather conditions (e.g., wind, sunlight intensity, precipitation, visibility, etc.), a path of mobile sub-targets through the target, and mobile sub-target parameters (e.g., if carrier-capable surveillance aircraft cannot keep pace with mobile sub-targets, the aircraft may start ahead of sub-targets, but eventually fall behind, at which point they can take a shortcut to get ahead of at least one of the sub-targets or go to an available aerostat node for docking). In a specific implementation, the aerostat nodes are immobile after reaching a starting position. For example, aerostat nodes may be moved to positions along a raceway and remain in those positions for the duration of one or more races. In an alternative, aerostat nodes are mobile with routes that are dynamically modified to keep pace with (or at least follow) mobile sub-targets. In a specific implementation, the route of the carrier-capable surveillance aircraft are dynamically modified based on results of the monitoring. For example, when a mobile sub-target of the target moves away from other sub-targets, the velocity of one of the carrier-capable surveillance aircraft may be modified to match the velocity of the sub-target. As another example, carrier-capable surveillance aircraft can be coordinated to maintain surveillance of a sub-target of high interest by having a first aircraft that is low on power be swapped out for a second aircraft, allowing the first aircraft to dock while the second aircraft takes over surveillance of the sub-target. An example of an airborne aircraft carrier is the aerostat 806 (FIG. 8) and examples of the carrier-capable surveillance aircraft are the carrier-capable surveillance aircraft 808 (FIG. 8). See also, FIGS. 4 and 6.

In the example of FIG. 9, the flowchart 900 continues to module 904 with causing the airborne aircraft carrier to assume a starting position. In a specific implementation, assuming the starting position entails taking off with docked carrier-capable surveillance aircraft and moving at least vertically, but potentially also laterally, to a predetermined aerial starting position. Alternatively, the carrier-capable surveillance aircraft can take off on their own or be launched separately from the airborne aircraft carrier. In a specific implementation, the airborne aircraft carrier is implemented as an immobile aerostat node for a period of time, such as the duration of a race that spans a target monitored region.

In the example of FIG. 9, the flowchart 900 continues to module 906 with deploying the carrier-capable surveillance aircraft. The route of the carrier-capable surveillance aircraft can be computed at any time prior to deployment and provided to the carrier-capable surveillance aircraft any time thereafter. For example, the carrier-capable surveillance aircraft programmed before the start of a mission, at start-of-mission, while docked at the airborne aircraft carrier, or at some other time. The flight plan of the carrier-capable surveillance aircraft will also typically include surveillance instructions, which may include continuous feed, store and forward, store for batch processing, discrete capture (e.g., snapshot), or the like. Depending upon implementation- and/or configuration-specific factors, a first carrier-capable surveillance aircraft can act as a repeater for a second carrier-capable surveillance aircraft when the second carrier-capable surveillance aircraft is not within wireless communication range of an applicable wireless receiver. Surveillance instructions can also be altered dynamically, such as when power is lower for one of the carrier-capable surveillance aircraft, but not others, and the low-power carrier-capable surveillance aircraft switch from continuous feed to discrete capture or from store-and-forward to store for batch processing.

In the example of FIG. 9, the flowchart 900 continues to module 908 with causing a first carrier-capable surveillance aircraft of the carrier-capable surveillance aircraft and a second carrier-capable surveillance aircraft of the carrier-capable surveillance aircraft to monitor first and second mobile sub-targets. Moreover, the route can be dynamically altered as information is obtained about a target, environmental conditions, or the like. For example, carrier-capable surveillance aircraft can be deployed just prior to the start of a race and spread out to follow specific sub-targets (e.g., a leader, a famous participant, etc.) or carrier-capable surveillance aircraft might only be deployed later, such as when a group of sub-targets breaks into a first group and a second group that are sufficiently separate from one another to make surveillance of both groups impossible or degraded in some way (e.g., resolution, ideal angle, etc.).

In the example of FIG. 9, the flowchart 900 continues to decision point 910 with determining whether a carrier-capable surveillance aircraft has reached a time-to-dock threshold. If it is determined a time-to-dock threshold has not been reached (910—No), the flowchart 900 returns to module 908 and continues as described previously. If, on the other hand, it is determined a time-to-dock threshold has been reached (910—Yes), the flowchart 900 continues to module 912 with causing the carrier capable surveillance aircraft to return to the airborne aircraft carrier until such time as a time-to-deploy threshold is reached (e.g., after recharging) or the mission ends. During the return to the airborne aircraft carrier, surveillance may or may not continue.

In the example of FIG. 9, the flowchart 900 continues to decision point 914 with determining whether a carrier-capable surveillance aircraft has reached a time-to-deploy threshold. If it is determined a time-to-deploy threshold has been reached (914—Yes), the flowchart 900 returns to module 908 and continues as described previously. If, on the other hand, it is determined a time-to-deploy threshold has not been reached (914—No), the flowchart 900 continues to decision point 916 where it is determined whether the mission is complete. If it is determined the mission is not complete (916—No), the flowchart returns to module 912 and continues as described previously. If, on the other hand, it is determined the mission is complete (916—Yes), the flowchart continues to module 918 with causing the airborne aircraft carrier to proceed to a mission-complete location. In a specific implementation, the mission-complete location is the same as the starting position.

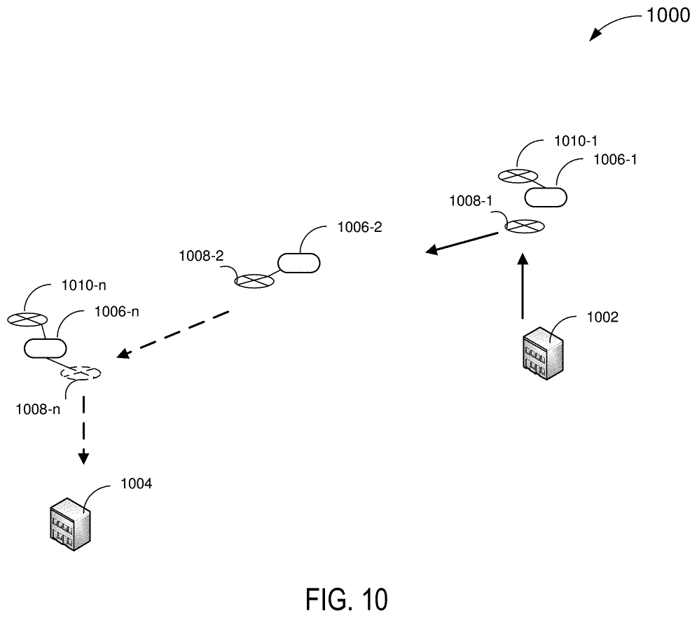

FIG. 10 is a diagram 1000 of an example of an aerostat network system with carrier-capable aircraft that travel between aerostat nodes. FIG. 10 is intended to illustrate a variation on the system described in association with FIG. 4; specifically, for illustrative purposes, payload is introduced into the network at a first aerostat network ground station and removed from the aerostat network at a second aerostat network ground station. The diagram 1000 includes a first aerostat network ground-based station 1002, a second aerostat network ground-based station 1004, an aerostat 1006-1 to an aerostat 1006-n (collectively, the aerostats 1006), a carrier-capable aircraft 1008-1 to a carrier-capable aircraft 1008-n (collectively, the carrier-capable aircraft 1008), and a carrier-capable aircraft 1010-1 to a carrier-capable aircraft 1010-n (collectively, the carrier-capable aircraft 1010). In a specific implementation, the aerostats 1006 are part of respective aerostat nodes, such as was described previously with reference to FIG. 1 (see, e.g., aerostat network nodes 104) and the carrier-capable aircraft 1008 are part of an internodal conveyances, such as was described previously with reference to FIG. 1 (see, e.g., internodal conveyances 112). See also, aerostats 404 (FIG. 4) and carrier-capable aircraft 406 (FIG. 4).

In the example of FIG. 10, the aerostat network ground base station 1002 is intended to represent a ground facility by which payload is introduced into an aerostat network. The aerostat network ground base station 1002 is intended to represent a ground-based portion of an aerostat network gateway node, which may include an airport, train station, bus terminal, port, or some other staging area from which payload can be introduced into the aerostat network.

In the example of FIG. 10, the aerostat network ground base station 1004 is intended to represent a ground facility at which payload is discharged from the aerostat network. The aerostat network ground base station 1004 is intended to represent a ground-based portion of an aerostat network gateway node, which may include an airport, train station, bus terminal, port, or some other platform onto which payload can be discharged from the aerostat network.

In a specific implementation, the aerostat network ground base station 1004 is located within a distance from the aerostat network ground base station 1002 that is shorter than those of a conventional commercial airplane-based transportation system. For example, aerostat network ground base station 1002 and the aerostat network ground base station 1004 could be distanced from each other with a range of 50-150 kilometers. Alternatively or in addition, the aerostat network ground base station 1004 could be located where other transportation systems are less convenient, such as above a skyscraper in a busy city.

In the example of FIG. 10, the aerostats 1006 are intended to represent aerostats of an aerostat network node that may or may not have a corresponding ground-based station. For example, in the diagram 1000, the aerostats 1006-1 and 1006-n are depicted near the aerostat network ground base stations 1002 and 1004, respectively, but an aerostat network ground base station is intentionally omitted near the aerostat 1006-2 for illustrative purposes. While the first and last aerostats 1006-1, 1006-n are at gateway aerostat network nodes, a set of zero or more aerostats 1006-2 to 1006-n−1 (not shown) are intended to represent aerostats at intermediate aerostat network nodes that are not gateway aerostat network nodes (though they could be gateways to networks that are not part of the path illustrated in the diagram 1000). In a specific implementation, the aerostats 1006 serve as a mid-air docking stations in an aerostat network. In an implementation in which the aerostats 1006 serve as a mid-air docking stations, one or more of the aerostats 1006 can have a space to accommodate payload, such as to allow passengers a place to wait in a modicum of comfort or a break-bulk area for cargo. In a specific implementation, one or more of the aerostats 1006 serve as a charging station for carrier-capable aircraft. In an implementation in which one or more of the aerostats 1006 serve as a charging station for carrier-capable aircraft, one or more of the aerostats 1006 are implemented with an applicable charging port for wired or wireless charging, with or without a corresponding docking station, to which carrier-capable aircraft can be coupled for charging.

In the example of FIG. 10, the carrier-capable aircraft 1008 are intended to represent one or more carrier-capable aircraft that transport payload from the aerostat network ground base station 1002 to the aerostat network ground base station 4 1004. In a specific implementation, payload is transferred from a first carrier-capable aircraft of the carrier-capable aircraft 1008 to a second carrier-capable aircraft of the carrier-capable aircraft 1008 at each aerostat network node. Alternatively, a carrier-capable aircraft of the carrier-capable aircraft 1008 can recharge at an aerostat network node without transferring payload to another carrier-capable aircraft. Thus, the diagram 1000 is intended to illustrate a single carrier capable aircraft at each of 1008-1, 1008-2, and 1008-n, or up to ‘n’ carrier capable aircraft, depending upon implementation- and/or configuration-specific factors.

In the example of FIG. 10, the carrier-capable aircraft 1010 are intended to represent zero or more carrier capable aircraft that can be used to traverse the same path as the carrier-capable aircraft 1008 or some other path.

In an example of operation, the aerostats 1006 assume a start-of-mission position, which may be a stationary position for the duration of the mission. The aerostats 1006 may or may not be above a ground base station and those with a ground base station may be offset from the corresponding ground base station (e.g., the aerostat 1006-1 may be offset from the aerostat network ground base station 1002 in the direction of the aerostat network ground base station 1004 and the aerostat 1006-n may be offset from the aerostat network ground base station 1004 in the direction of the aerostat network ground base station 1006). The one or more carrier-capable aircraft 1008 take on payload at the aerostat network ground station 1002 (or the aerostat 1006-1), fly to zero or more intermediate aerostat network nodes, such as the one that includes the aerostat 1006-2, and discharge payload at the aerostat network ground station 1004 (or the aerostat 1006-n). Depending upon whether the carrier-capable aircraft transfer payload from one to another at one or more nodes, the number of carrier-capable aircraft can vary between one and one less than the number of aerostat nodes traversed. Advantageously, when a path would otherwise require multiple hops, a carrier-capable aircraft does not need to land and take off (or land and transfer payload to a second carrier-capable aircraft that takes off) from an intermediate node between a source node and a destination node, which consumes time and a great deal of energy. Instead, the carrier-capable aircraft can dock at an aerial platform and flight can be continued without landing and subsequent take-off (whether or not payload is transferred to a second carrier-capable aircraft at the intermediate node). For this reason, significant time and energy cost for the descending and ascending at an intermediate node can be saved using an aerostat network.

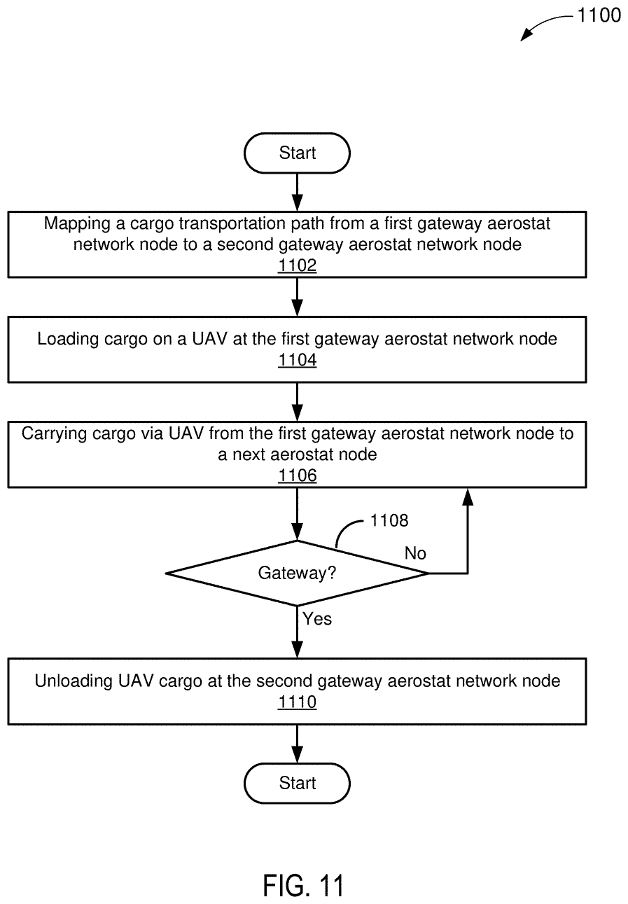

FIG. 11 is a flowchart 1100 of an example of a method for payload transportation using an aerostat network with carrier-capable aircraft that travel between aerostat nodes. FIG. 11 is intended to illustrate a variation on the method described in association with FIG. 5, specifically, for illustrative purposes, the method starts at a first gateway aerostat network node and ends at a second gateway aerostat network node. The flowchart 1100 starts at module 1102, with mapping a cargo transportation path from a first gateway aerostat network node to a second gateway aerostat network node. In a specific implementation, an aerostat network management system maps the cargo transportation path from a first gateway aerostat network node to a second gateway aerostat network node.

The flowchart 1100 continues to module 1104 with loading cargo on a UAV at the first gateway aerostat network. The UAV can be loaded with cargo at a ground base station or at an aerostat.

The flowchart 1100 continues to module 1106 with carrying cargo via UAV from the first gateway aerostat network node to a next aerostat node. At each next aerostat node, or a subset thereof, the cargo may be subjected to break-bulk, containerization, transfer to a different transportation vehicle, or the like.

The flowchart 1100 continues to decision point 1108 where it is determined whether the next aerostat node is the second gateway aerostat node. If it is determined the next aerostat node is the second gateway aerostat node (1108—Yes), then the flowchart 1100 ends at module 1110 with unloading UAV cargo at the second gateway aerostat network node. The UAV can be unloaded at a ground base station or at an aerostat. If, on the other hand, it is determined the next aerostat node is not the second gateway aerostat node (1108—No), then the flowchart 1100 returns to module 1106 and continues as described previously.

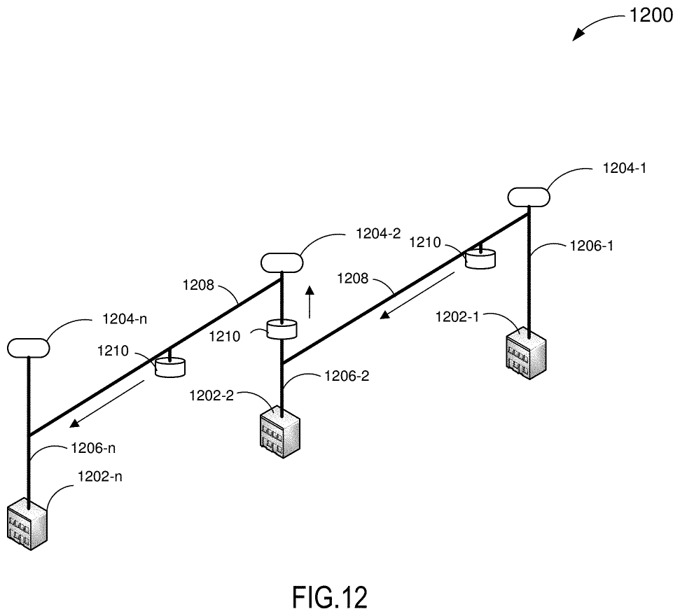

FIG. 12 is a diagram 1200 of an example of an aerostat network with intranodal conveyances. The diagram 1200 includes a ground base station 1202-1 to a ground base station 1202-n (collectively, the ground base stations 1202), an aerostat 1204-1 to an aerostat 1204-n (collectively, the aerostats 1204), an intranodal cable 1206-1 to an intranodal cable 1206-n (collectively, the intranodal cables 1206) respectively connecting the ground base stations 1202 to the aerostats 1204, internodal cables 1208 operationally connecting the aerostats 1204 with one another, and internodal vehicles 1210 that traverse the internodal cables 1206 and the internodal cables 1208. In a specific implementation, the aerostats 1204 are part of respective aerostat nodes, such as was described previously with reference to FIG. 1 (see, e.g., aerostat network nodes 104) and the internodal cables 1208 and internodal vehicles 1210 are part of internodal conveyances, such as was described previously with reference to FIG. 1 (see, e.g., internodal conveyances 112).

In the example of FIG. 12, the ground base stations 1202 are intended to represent a ground facility to and/or from which passengers or cargo are introduced into and/or out of the aerostat network. In a specific implementation, the ground base stations 1202 are on the top of buildings in a city. The ground base stations 1202 can be separated by up to 300 meters, though the distance could be increased with sufficiently resilient cables and sufficiently open thoroughfare. In some embodiments, the aerostat-based transportation system in FIG. 12 is suitably applied to a metropolitan area (e.g., New York City, Los Angeles, Chicago, etc.) having a substantial number of high-rise buildings, and the ground base stations 1202 are implemented atop some of the high-rise buildings.

In the example of FIG. 12, the aerostats 1204 are intended to represent mid-air structures to attached to corresponding ground base stations and one another. The aerostats 1204 are configured to have sufficient buoyancy to maintain tension of in the intranodal cables 1206.

In the example of FIG. 12, the intranodal cables 1206 are intended to serve as a vertical transportation cable by which payload can be lifted from the base stations 1202 to the corresponding aerostats 1204. In a specific implementation, the intranodal cables 1206 are let out or taken in to change elevation of the aerostats 1204, thereby changing pitches of the operationally connected internodal cables 1208. For example, a winch can be used to shorten or lengthen the intranodal cables 1206, thereby pulling the corresponding aerostats 1204 down toward the corresponding ground base stations 1202 or allowing the corresponding aerostats 1204 to float upward away from the corresponding ground base stations 1202.

In the example of FIG. 12, the internodal cables 1208 are intended to serve as a lateral transportation cable by which payload can be slid between operationally connected ones of the aerostats 1204. In a specific implementation, the intranodal cables 1206 are affixed via a joint to the internodal cables 1208 underneath the aerostats 1204. A mechanical switch at or near the joint is configured to release

In the example of FIG. 12, the internodal vehicles 1210 serve as a container of the aerostat network. The container can be implemented as, for example, a gondola with space to accommodate payload. In a specific implementation, the internodal vehicles 1210 are lifted when the intranodal cables 1206 are lengthened to allow the aerostats 1204 to rise and lowered when the intranodal cables 1206 are shortened, causing the aerostats 1204 to come down. In addition, the internodal vehicles 1210 can lose elevation due to gravitational force as the internodal vehicles slide along the internodal cables 1208 from a higher-elevation aerostat to a lower-elevation aerostat of the aerostats 1204.

In a specific implementation, the internodal vehicles 1210 include a mechanical switch that is configured to change from an intranodal cable clamp position to an intranodal hook position. The intranodal clamp position causes the internodal vehicles 1210 to maintain a fixed position relative to the intranodal cables 1206, while the intranodal hook position allows lateral movement along the internodal cables 1208. Instead or in addition, the internodal vehicles 1210 include a pulley to assist in traversing the internodal cables 1206 and/or the intranodal cables 1208.

In an example of operation, the aerostats 1204 assume a starting state respectively above the ground base stations 1202 with tension along the intranodal cables 1206 due, at least in part, to the buoyancy of the aerostats 1204. The internodal cables 1208 have pitches that vary depending upon the elevations of the ones of the aerostats 1204 that share relevant ones of the internodal cables 1208. Internodal vehicles 1210 are laden with payload at the ground base stations 1202 that have a corresponding one of the aerostats 1204 in a low elevation state. The internodal vehicles 1210 are lifted up from the ground base stations 1202 due to a lengthening of the relevant ones of the intranodal cables 1206 and the corresponding rise of the relevant ones of the aerostats 1204 due to the buoyant force of the aerostats 1204. When the aerostats 1204 reach a relatively high elevation state, an intranodal clamp of the internodal vehicles 1210 is released to allow the internodal vehicles 1210 to slide along the internodal cables 1208 towards adjacent ones of the aerostats 1204 that are in a relatively low elevation state.

A relatively high elevation state for a first aerostat is somewhere between low elevation state and high (or maximum) elevation state, but higher than the elevation of a second aerostat with which the first aerostat is operationally connected via an internodal cable. Similarly, a relatively low elevation state for a first aerostat is somewhere between low elevation state and high elevation state, but lower than the elevation of a second aerostat with which the first aerostat is operationally connected via an internodal cable. It may be noted that base stations need not be located at the same elevations, so a high elevation state of a first aerostat might be lower than a low elevation state of a second aerostat. However, to facilitate bi-directional transport, it may be desirable to enable a first aerostat to be configurable between a high elevation state or a low elevation state relative to a second aerostat (and, ipso facto, vice versa).

Continuing the example of operation, internodal vehicles 1210 can continue from aerostat to aerostat until reaching a destination by having the aerostats change elevation state to allow the internodal vehicles 1210 to slide to a next aerostat node. Upon reaching a destination node, the aerostat can be brought to a low elevation state and passengers can disembark or cargo can be unloaded at the relevant base station.

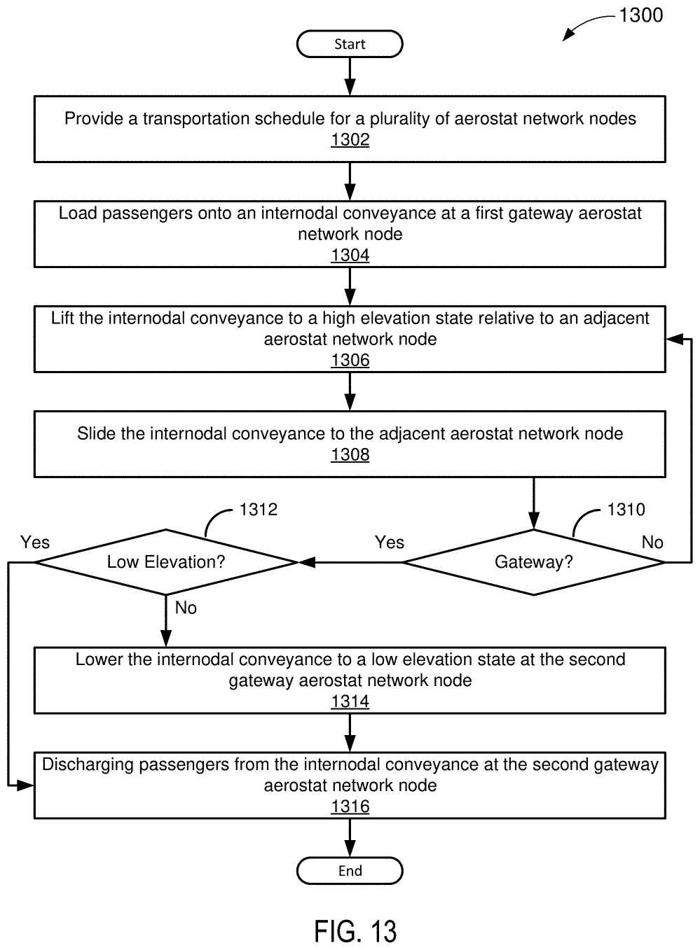

FIG. 13 is a diagram 1300 of an example of a method for moving an internodal conveyance through an aerostat network. The flowchart 1300 starts at module 1302, with providing a transportation schedule for a plurality of aerostat network nodes. In a specific implementation, an aerostat network management system creates the transportation schedule based on explicit human or artificial administrator agent designations or develops a transportation schedule by weighing factors such as passenger reservations, weather conditions (e.g., wind, sunlight intensity, precipitation, visibility, etc.), maintenance schedules, time of day (e.g., rush hour), or the like to improve throughput, meet quality of service goals, maximize occupancy, or the like.

In the example of FIG. 13, the flowchart 1300 continues to module 1304 with loading passengers onto an internodal conveyance at a first gateway aerostat network node. In a specific implementation, the passengers are loaded onto the internodal conveyance at a ground base station of the first gateway aerostat network node while a first aerostat is at a low elevation state. The passengers can also be loaded in accordance with the transportation schedule to reduce the amount of time passengers may have to wait while aboard and in transit.

In the example of FIG. 13, the flowchart 1300 continues to module 1306 with lifting the internodal conveyance to a high elevation state relative to an adjacent aerostat network node. In a specific implementation, the relatively high elevation state is at least as high as a joint connecting an intranodal cable to an internodal cable. In a specific implementation, the internodal conveyance is lifted by letting out intranodal cable and allowing the buoyancy of an aerostat connected to the intranodal cable to maintain tension on the intranodal cable and lift the internodal conveyance that is attached thereto.

In the example of FIG. 13, the flowchart 1300 continues to module 1308 with sliding the internodal conveyance to the adjacent aerostat network node. In a specific implementation, gravitational force causes the internodal conveyance, which is at a relatively high elevation state, to move to the adjacent aerostat network node, which is at a relatively low elevation state.

In the example of FIG. 13, the flowchart 1300 continues to decision point 1310 with determining whether the adjacent aerostat network node is the second gateway aerostat network node. If it is determined the adjacent aerostat network node is not the second gateway aerostat network node (1310—No), then the flowchart 1300 returns to module 1306 and continues as described previously. If, on the other hand, it is determined the adjacent aerostat network node is the second gateway aerostat network node (1310—Yes), then the flowchart 1300 continues to decision point 1312 with determining whether the second gateway aerostat network node is at a low elevation state. If it is determined the second gateway aerostat network node is not at a low elevation state (1312—No), then the flowchart 1300 continues to module 1314 with lowering the internodal conveyance to a low elevation state at the second gateway aerostat network node and ends at module 1316 with discharging passengers from the internodal conveyance at the second gateway aerostat network node. If, on the other hand, it is determined the second gateway aerostat network node is at a low elevation state (1312—Yes), then the flowchart 1300 ends at module 1315, which was described previously. The flowchart 1300 has an implicit assumption that the passengers are all intended for the same destination, but a similar approach can be taken where some passengers disembark at aerostat network nodes and the internodal conveyance continues to pick up and discharge passengers with per-passenger destinations, but, for practical purposes, no final destination.

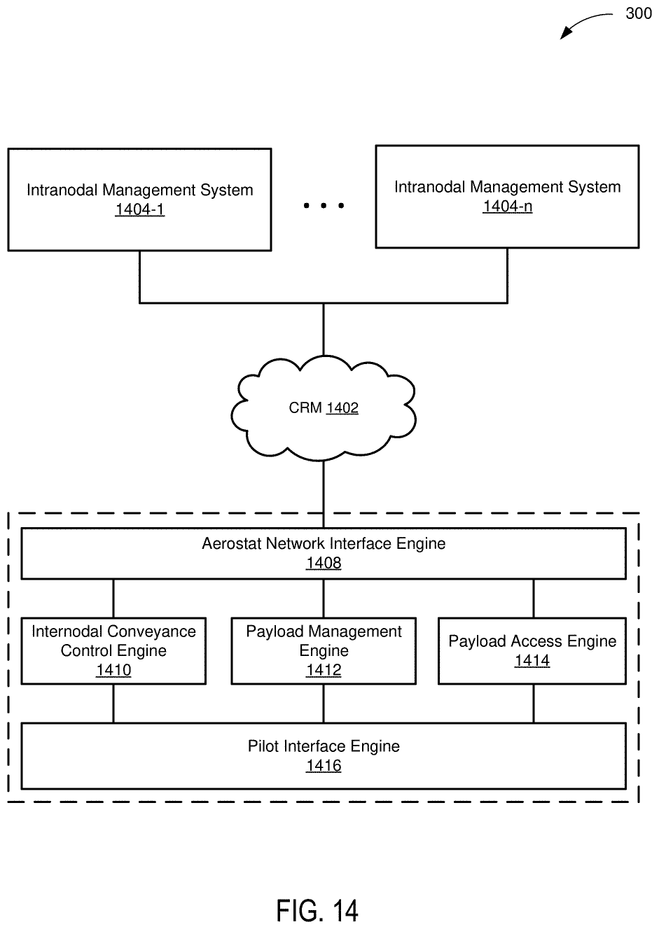

FIG. 14 is a diagram 1400 of an example of an aerostat network management system. The diagram 1400 is intended to illustrate an example of a system that can be used by the aerostat networks described above. The diagram 1400 includes a CRM 1402, an intranodal management system 1404-1 to an intranodal management system 1404-n (collectively, the intranodal management systems 1404) coupled to the CRM 1402, and an aerostat network management system 1406 coupled to the CRM 1402.

In the example of FIG. 14, the CRM 1402 is intended to include a wireless medium traversable by electromagnetic, acoustic, or other signals and applicable hardware nodes, such as repeaters, cell towers, satellites, or the like. In a minimalist implementation, the CRM 1402 includes no hardware, and simply acts as a medium for carrying wireless signals between, at least, the intranodal management systems 1404 and the aerostat network management system 1406, but in various implementation the CRM 1402 also includes, for example, GPS satellites, repeaters, cell towers, or the like. In general, wireless communication can be defined as the transfer of information or power between two or more points that are not connected by an electrical conductor. The most common wireless technologies use radio waves.

The intranodal management systems 1404 can be implemented as unmanned aircraft systems (UAS) to control unmanned aerial vehicles (UAV). The term unmanned aircraft system was adopted by the United States Department of Defense (DoD) and the United States Federal Aviation Administration in 2005 according to their Unmanned Aircraft System Roadmap 2005-2030 and the International Civil Aviation Organization (ICAO) and the British Civil Aviation Authority adopted this term, also used in the European Union's Single-European-Sky (SES) Air-Traffic-Management (ATM) Research (SESAR Joint Undertaking) roadmap for 2020. The term UAS emphasizes the importance of elements other than the aircraft and includes elements such as ground control stations, data links and other support equipment. A UAV is defined as a “powered, aerial vehicle that does not carry a human operator, uses aerodynamic forces to provide vehicle lift, can fly autonomously or be piloted remotely, can be expendable or recoverable, and can carry a lethal or nonlethal payload.” RPAV is a similar term that is typically an acronym of “remotely piloted aerial vehicle.”

The aerostat network management system 1406 includes an aerostat network interface engine 1408, an internodal conveyance control engine 1410, a payload management engine 1412, a payload access engine 1414, and a pilot interface engine 1416. In a specific implementation, the aerostat network interface engine 1408 includes a radio communication subsystem with a transmitter and/or receiver (collectively, e.g., a transceiver), an antenna array of one or more antennas, and appropriate terminal equipment (including, e.g., input, output, or I/O devices), which may or may not be distributed across aerostat network nodes.

As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a CRM for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Memory can be characterized as a datastore. As used in this paper, datastores are intended to include repositories having any applicable organization of data, including computer instructions, tables, comma-separated values (CSV) files, traditional databases (e.g., SQL), or other applicable known or convenient organizational formats. Datastores can be implemented, for example, as software embodied in a physical computer-readable medium (CRM) on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Referring once again to the example of FIG. 14, the internodal conveyance control engine 1410 is intended to represent the hardware (e.g., processor, memory, etc.) specifically purposed (often via software) to enable helm, navigation, and/or engineering control of UAV. The internodal conveyance control engine 1410 can also control the braking or clamping of internodal conveyances that traverse aerostat nodes via cable. Flight plans or other instructions can be provided to internodal conveyances in advance of deployment, making real-time communication unnecessary in some implementations.

The payload management engine 1412 is intended to represent hardware specifically purposed to manage payload to be conveyed by an aerostat and/or a internodal conveyance. For example, the payload management engine 1412 determines a ground base station associated with an aerostat as an intermediary destination of payload from which the payload is conveyed through the air by the aerostat or the internodal conveyance and cause the payload to be conveyed to the determined ground base station. In an example in which the payload is cargo, the payload management engine 1412 determines a destination of the cargo based on data read from a tag (e.g., RFID tag) attached to the cargo or a container thereof and determines a route to the destination, including which aerostat network node through which to pass and which internodal conveyance is to be used. In some embodiments, based on payload management data of the payload generated by the payload management engine 1412, the internodal conveyance control engine 1410 determines flight schedule of aerostats and/or internodal conveyance based on the payload management data, and assigns payload to be conveyed to the aerostats and/or internodal conveyances. In a specific implementation, the payload management engine 1412 includes a payload-related datastore that can be accessed as signals are received via the aerostat network interface engine 310. Alternatively or in addition, the payload-related datastore can be implemented elsewhere, such as in the cloud and may or may not be accessible via the intranodal management systems 1404.

The payload access engine 1414 is intended to represent hardware specifically purposed to create, update, or delete instructions associated with a payload installed on the internodal conveyances, which are transmitted to the internodal conveyances via the aerostat network interface engine 1408. Instructions can also be provided via some other source than the payload access engine 1414. In a specific implementation, the payload access engine 1414 includes a payload-related datastore that can be accessed as signals are received via the aerostat network interface engine 1408. Alternatively or in addition, the payload-related datastore can be implemented elsewhere, such as in the cloud and may or may not be accessible via the intranodal management system 1404. As used in this paper, “access” is intended to mean one or more of creation, reading, updating, or deleting data in a datastore.

The pilot interface engine 1416 is intended to represent hardware specifically purposed to receive input from a human or artificial agent at the intranodal management system 1404 and to provide output for the human or an artificial agent at the intranodal management system 1404. Input devices can be implemented as a joystick or other dedicated devices, via a touchscreen, or through some other applicable user interface. Depending upon implementation- and/or configuration-specific factors, the pilot interface engine 1416 may also provide output to the human or artificial agent. Output devices can be implemented as LEDs or other dedicated devices, via a display, or through some other applicable user interface. In a specific implementation, the pilot interface engine 1416 is also used to provide input from the human or an artificial agent to the payload management engine 1412. Instead or in addition, the pilot interface engine 1416 can provide output to the human or an artificial agent from the payload management engine 1414.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

What is claimed is:

1. A system comprising:
a plurality of aerostat network nodes along a payload conveyance path;
a respective plurality of aerostats at the plurality of aerostat network nodes;
a respective plurality of airborne platforms at the plurality of aerostat network nodes, wherein an airborne platform of the respective plurality of airborne platforms is airborne at least in part by virtue of being connected to an aerostat of the respective plurality of aerostats while the aerostat is airborne;
a respective plurality of sets of internodal conveyances at the plurality of aerostat network nodes, wherein a set of internodal conveyances of the respective plurality of sets of internodal conveyances are carrier-capable aircraft configured to dock at the airborne platform;
wherein the plurality of aerostat network nodes include:
an intranodal aerostat control subsystem with hardware and software used to pilot one of the respective plurality of aerostats;
an intranodal logistics subsystem with hardware and software used to manage one set of the respective plurality of sets of internodal conveyances and payloads conveyed thereby;
an aerostat network management system coupled to the plurality of aerostat network nodes.

2. The system of claim 1 wherein at least one of the plurality of aerostat network nodes is a gateway aerostat node.

3. The system of claim 1 wherein at least a subplurality of the plurality of aerostat network nodes are serially arranged.

4. The system of claim 1 wherein at least a subplurality of the plurality of aerostat network nodes have a hub and spoke topology.

5. The system of claim 1 wherein at least a subplurality of the plurality of aerostat network nodes have a mesh topology.

6. The system of claim 1 wherein the airborne platform is a first airborne platform and wherein a second airborne platform of the respective plurality of airborne platforms includes storage for cargo.

7. The system of claim 1 wherein the airborne platform is a first airborne platform and wherein a second airborne platform of the respective plurality of airborne platforms includes space for arriving or departing passengers.

8. The system of claim 1 wherein the airborne platform is a first airborne platform and wherein a second airborne platform of the respective plurality of airborne platforms includes persistent storage.

9. The system of claim 1 wherein the intranodal aerostat control subsystem receives aerostat status information from the airborne platform.

10. The system of claim 1 wherein the intranodal logistics subsystem receives intranodal conveyance and payload status information from the airborne platform.

11. The system of claim 1 wherein an internodal conveyance of the respective plurality of sets of internodal conveyances is an unmanned aircraft vehicle (UAV).

12. The system of claim 1 wherein an internodal conveyance of the respective plurality of sets of internodal conveyances includes cargo space.

13. The system of claim 1 wherein an internodal conveyance of the respective plurality of sets of internodal conveyances includes passenger space.

14. The system of claim 1 wherein an internodal conveyance of the respective plurality of sets of internodal conveyances includes non-volatile storage to carry collected data.

15. The system of claim 1 wherein an internodal conveyance of the respective plurality of sets of internodal conveyances includes deck space.

16. The system of claim 1 wherein an internodal conveyance of the respective plurality of sets of internodal conveyances includes a shackle suitable for attachment to a container carried by the internodal conveyance.

17. The system of claim 1 wherein the airborne platform includes an airborne aircraft carrier.

18. The system of claim 1 wherein:
the hardware and software used to pilot one of the respective plurality of aerostats includes ground-based wireless control hardware and software;
the hardware and software used to manage one set of the respective plurality of sets of internodal conveyances and payloads conveyed thereby includes ground-based wireless control hardware and software.

19. A method comprising:
determining a route of an airborne aircraft carrier and one or more carrier-capable surveillance aircraft based on characteristics of a target;
causing the airborne aircraft carrier to assume a starting position for a mission;
deploying carrier-capable surveillance aircraft;
causing the airborne aircraft carrier to fly in coordination with the carrier-capable surveillance aircraft;
surveilling a target until time-to-dock;
causing the carrier-capable surveillance aircraft to return to the airborne aircraft carrier where it remains until time-to-deploy;
causing the airborne aircraft carrier to assume a mission complete position when the mission is complete.

20. A system comprising:
a means for determining a route of an airborne aircraft carrier and one or more carrier-capable surveillance aircraft based on characteristics of a target;
a means for causing the airborne aircraft carrier to assume a starting position for a mission;
a means for deploying carrier-capable surveillance aircraft;
a means for causing the airborne aircraft carrier to fly in coordination with the carrier-capable surveillance aircraft;
a means for surveilling a target until time-to-dock;
a means for causing the carrier-capable surveillance aircraft to return to the airborne aircraft carrier where it remains until time-to-deploy;
a means for causing the airborne aircraft carrier to assume a mission complete position when the mission is complete.
